(19) United States
(12) Patent Application Publication
(10) Pub. No.: US 2010/0094766 A1
(43) Pub. Date: Apr. 15, 2010

(54) INSURANCE CONFIGURATION MANAGEMENT SYSTEM AND METHOD

(75) Inventors: Donghui Li, Toronto (CA); Brenda Heinen, Bloomingburg, NY (US); Mike Guiette, Saint Charles, MI (US); Jeff Hostetler, Troy, MI (US)

Correspondence Address: FITCH, EVEN, TABIN & FLANNERY, P. O. BOX 18415, WASHINGTON, DC, 20036, US

(73) Assignee: BLUE CROSS BLUE SHIELD OF MICHIGAN, Detroit, MI (US)

(21) Appl. No.: 12/238,963

(22) Filed: Sep. 26, 2008

(51) Int. Cl. G06Q 10/00; G06F 9/44

(52) U.S. Cl. 705/322; 717/136

(57) ABSTRACT

A method, system, and computer program product to provide a single platform to unify benefits, claims, membership, billing, and servicing. One embodiment provides a computer program-assisted system to provide a single point source for host benefits management having a centralized benefit data manager (BDM); a selector communicatively connected to said BDM to allow a user to view, select, and assemble benefit components from BDM; an editor communicatively connected to the BDM allows the ability to define and update benefit components and variables for benefit and payment policies; a read-only explainer communicatively connected to the BDM provides understandable “read-only” descriptions of benefits available; and a connector communicatively connected to the BDM as an interface layer to exchange electronic benefit data with all system processes, including external claims systems. The connector can translate rules from a user's natural language to computer code language.

### FIELD OF THE INVENTION

The present invention is related to the field of insurance benefits management and, more particularly, to a method, system, and computer program product to provide a single point source for host benefits management such as for health care, which allows defining, selecting, editing, explaining, and connecting benefit plans, and automatic loading of benefit data to various claims and membership processing systems.

### BACKGROUND OF INVENTION

Health care insurance is an example of a customized service plan with complex relationships and rules that affect cost, services provided, interpretation of rules, and the like. A core problem in the art is that benefits data are conventionally loaded across multiple systems subject to interpretations by the people who load them, review them, and ultimately the end user.

There are known attempts in the art to address the management of insurance benefit information. U.S. application Ser. No. 10/322,381 to Sears et al. describes a system to create an insurance quote for providing an insurance benefit. U.S. application Ser. No. 09/739,448 to Johnson et al. describes a system to select a benefits plans based on customer data input. U.S. application Ser. No. 10/620,429 to Cadigan et al. describes a system with some rudimentary claims-related customer service tools and claims processing.

Unfortunately, the prior art has only provided point solutions that still require multiple applications and multiple interfaces to be maintained to address the overall management of health insurance care. Further, the old way of “doing business” in the art no longer adequately addresses the current health care climate or demand. There is too much data variability, no single source of reliable information, no “owner” of information, slow speed in the marketplace, and difficult coding issues to interface with users. Therefore, it is desirable in the art to provide a method and system to provide a single point source for host benefits management, such as health care benefits management, which allows defining, selecting, editing, explaining, and connecting benefit plans, and automatic loading of benefit data to claims to various membership processing systems.

### SUMMARY OF INVENTION

Accordingly, the present invention provides a method, system, and computer program product to provide a single platform to unify health benefits, claims, membership, billing, and servicing. The present invention provides for host benefits management, such as health care benefits management, which allows defining, selecting, editing, explaining, and connecting benefit plans, and automatic loading of benefit data to various claims and membership processing systems.

Specifically, one embodiment of the present invention provides a computer program assisted system to provide a single point source for host benefits management having a centralized benefit data manager (BDM), a selector communicatively connected to said BDM, an editor communicatively connected to the BDM, a read-only explainer communicatively connected to the BDM, and a set of connectors communicatively connected to the BDM.

The BDM can have at least one benefit package for at least one line of business, said benefit package having at least one product, said product representing a collection of benefit rules.

The selector can allow a user to view, select, and assemble benefit components from BDM into a benefit package per predefined medical, benefit, and payment policies.

The editor allows those with access the ability to define and update benefit components and variables for benefit and payment policies within BDM or documents within the BDM.

The explainer can present easily understandable “read-only” descriptions of benefits available at current or a predefined point in time at both a summary and detail rule level to a large variety of potential users.

The connector can be an interface layer to exchange electronic benefit data with external claims systems. The connector can translate rules from a user's natural language to computer code language.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE FIGURES

The foregoing features, as well as other features, will become apparent with reference to the description and figures below, in which like numerals represent like elements and in which:

FIG. 1 is a flow chart illustrating the component relationships of an insurance configuration and management system of one embodiment of the present invention.

FIG. 2 is a flow chart illustrating the major processes of an insurance configuration and management system of one embodiment of the present invention.

FIG. 3 is a structured representation of a benefit rule of one embodiment of the present invention.

FIG. 4 is an expanded structured representation of a benefit rule of one embodiment of the present invention.

FIG. 5 is a schematic representation of one embodiment of the present invention showing core objects associated with the connector.

FIG. 6 illustrates a diagram for an interface for the selector—home of one embodiment of the present invention.

FIG. 7 illustrates a diagram for an interface for the selector—create product plan of one embodiment of the present invention.

FIG. 8 illustrates a diagram for an interface for the selector—create benefit package of one embodiment of the present invention.

FIG. 9 illustrates a diagram for an interface for the selector—current benefits of one embodiment of the present invention.

FIG. 10 illustrates a diagram for an interface for the selector—activate benefit package of one embodiment of the present invention.

FIG. 11 illustrates a diagram for an interface for the selector—approve benefit package of one embodiment of the present invention.

FIG. 12 illustrates a diagram for an interface for the benefit editor component of one embodiment of the present invention showing a main editor.

FIG. 13 illustrates a diagram for an interface for the benefit editor component of one embodiment of the present invention showing a topic tree maintenance.

FIG. 14 illustrates a diagram for an interface for the benefit editor component of one embodiment of the present invention showing a maximum value maintenance.

FIG. 15 illustrates a diagram for an interface for the benefit editor component of one embodiment of the present invention showing a cost-share maintenance.

FIG. 16 illustrates a diagram for an interface for the benefit editor component of one embodiment of the present invention showing medical policy rules.

FIG. 17 illustrates a diagram for an interface for the benefit editor component of one embodiment of the present invention showing medical policy event assignment rules.

FIG. 18 illustrates a diagram for an interface for the benefit editor component of one embodiment of the present invention showing medical policy service class assignment rules.

FIG. 19 illustrates a diagram for an interface for the benefit editor component of one embodiment of the present invention showing contractual benefit rules.

FIG. 20 illustrates a diagram for an interface for the benefit editor component of one embodiment of the present invention showing managing rule statuses.

FIG. 21 illustrates a diagram for an interface for the benefit editor component of one embodiment of the present invention showing accumulator maintenance.

FIG. 22 illustrates a diagram for an interface for the benefit editor component of one embodiment of the present invention showing named list maintenance.

FIG. 23 illustrates a diagram for an interface for the benefit editor component of one embodiment of the present invention showing families.

FIG. 24 illustrates a diagram for an interface for the benefit editor component of one embodiment of the present invention showing products.

FIG. 25 illustrates a diagram for an interface for the document editor component of one embodiment of the present invention showing a log-in.

FIG. 26 illustrates a diagram for an interface for the document editor component of one embodiment of the present invention showing document categories.

FIG. 27 illustrates a diagram for an interface for the document editor component of one embodiment of the present invention showing a document categories example.

FIG. 28 illustrates a diagram for an interface for the document editor component of one embodiment of the present invention showing more document categories.

FIG. 29 illustrates a diagram for an interface for the document editor component of one embodiment of the present invention showing a utility to make changes.

FIG. 30 illustrates a diagram for an interface for the Explainer component of one embodiment of the present invention showing an introduction to the component.

FIG. 31 illustrates a diagram for an interface for the Explainer component of one embodiment of the present invention showing benefit package criteria.

FIG. 32 illustrates a diagram for an interface for the Explainer component of one embodiment of the present invention showing a benefit package criteria search.

FIG. 33 illustrates a diagram for an interface for the Explainer component of one embodiment of the present invention showing a benefit package criteria report.

FIG. 34 illustrates a diagram for an interface for the Explainer component of one embodiment of the present invention showing benefit package criteria with codes.

FIG. 35 illustrates a diagram for an interface for the Explainer component of one embodiment of the present invention showing provider specialty.

FIG. 36 illustrates a diagram for an interface for the Explainer component of one embodiment of the present invention showing maximums.

FIG. 37 illustrates a diagram for an interface for the Explainer component of one embodiment of the present invention showing contractual documents.

FIG. 38 illustrates a diagram for an interface for the Explainer component of one embodiment of the present invention showing provider manuals.

FIG. 39 illustrates a diagram for an interface for the Explainer component of one embodiment of the present invention showing source documents.

FIG. 40 illustrates a diagram for an interface for the Explainer component of one embodiment of the present invention showing switching of roles.

FIG. 41 illustrates a data flow diagram of an initiation and implementation of a benefit rule change of the editor of one embodiment of the present invention.

FIG. 42 illustrates a data flow diagram of product selection of the selector of one embodiment of the present invention.

FIG. 43 illustrates a data flow diagram of enrollment within the benefit configurator of one embodiment of the present invention.

FIG. 44 is a block diagram illustrating a network environment in which a system according to the present invention may be practiced.

FIG. 45 is a block diagram showing membership and benefit relationships within a benefit configurator environment in one embodiment of the present invention.

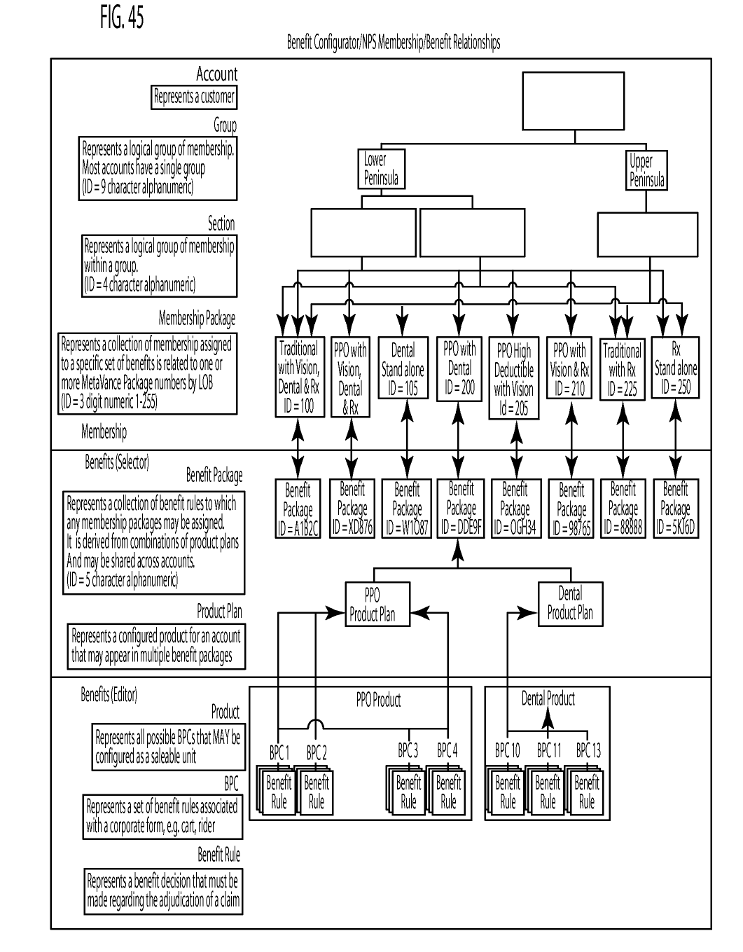

### DETAILED DESCRIPTION OF THE INVENTION

The present invention provides a single platform to unify health benefits, claims, membership, billing, and servicing under the basic philosophy that benefit rules must reside in a hierarchy that allows for inheritance from the more global definition to the more specific. In the art, there exists a problem that benefits data, such as for health care, are loaded across multiple systems. Interpretation of benefits is subject to variation, since several individuals are involved across those multiple systems. Further, in the art, benefits policies are written by multiple parties, which are then sent to different members of an organization for rules development. It is desired, and as is practiced with the present invention, the rules are the primary and initial source of benefits policy, and from these rules all other documents are created.

The present invention provides a method, system, and computer program product for insurance benefits management and, more particularly, to a method, system, and computer program product to provide a single point source for host benefits management, such as for health care, which allows defining, selecting, editing, explaining, and connecting benefit plans, and automatic loading of benefit data to various claims and membership processing systems. In the description of the present invention, one embodiment of the insurance benefit management system and method will be described as a health benefit manager, though other types of single point data management of benefits are possible.

The terms computer program, computer program product, and the like in the present context mean any expression, in any language, code, or notation, of a set of instructions intended to cause a system having an information processing capability to perform a particular function, either directly or after either or both of the following: (a) conversion to another language, code, or notation; and (b) reproduction in a different material or electronic form. In addition, this system may include a subscription. The subscription service could be an individual, a group of persons, or an organization to which a user has subscribed and provided sufficient information to enable the subscription to send program information to the subscriber and/or directly to the system. The subscription service may be associated with a user fee or a subscription rate.

The present invention, in a digital format, can be realized as methods or systems in hardware, software, or a combination of hardware and software of a computer system, including a computer network system, which may include the Internet (described in more detail below). The present invention can be realized in a centralized fashion in one computer system or in a distributed fashion, where different elements are spread across several computer systems. Any kind of computer system or other apparatus adapted for carrying out the methods described herein is suited. A typical combination of hardware and software may include a general purpose computer system with a computer program that, when being loaded and executed, controls the computer system such that it carries out the systems and methods described herein. The present invention may also be voluntarily embedded in a computer program product (or any computer-usable medium having computer-readable program code embodied therein) which comprises all the features enabling the implementation of the methods and systems described herein and which, when loaded in a computer system, is able to carry out these systems and methods.

Generally, the system and method of the present invention are configured to provide a system and method that has the ability: to search and retrieve standard benefits packages and products (i.e., a collection of certificates, riders, and modifications); select and assemble products into a benefit package per marketing policies, manage the selection of products and tie the selection to products, emphasizing the ease of selection; support Web-based tools for point of sale agents, groups, and members; work with rating products in support of the selection process; integrate with benefit component pricing algorithms and facts (renewal rating engine) for new and renewal business that incorporates claims experience; ability to modify changes and perform impact assessments; and locate correct benefit package data (descriptions and processing rules) based on member and applicable data.

As is described below, the benefit configurator will enable a user to change, add, delete, inquiry, and archive tracking and marketing support features that improve customer relationships at critical touch points for business departments, such as health care insurance companies, that need consistent member benefit information. The benefit configurator can improve a company's competitive position by providing the ability to efficiently obtain timely and accurate data. In short, the benefit configurator described below provides a product that can intelligently manage the synchronization of benefit data from medical and benefit policy through benefit operations and business support, all while maintaining data integrity.

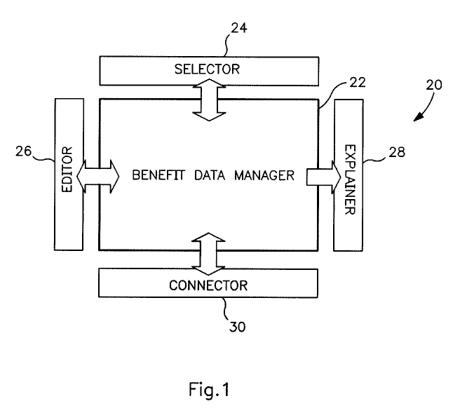

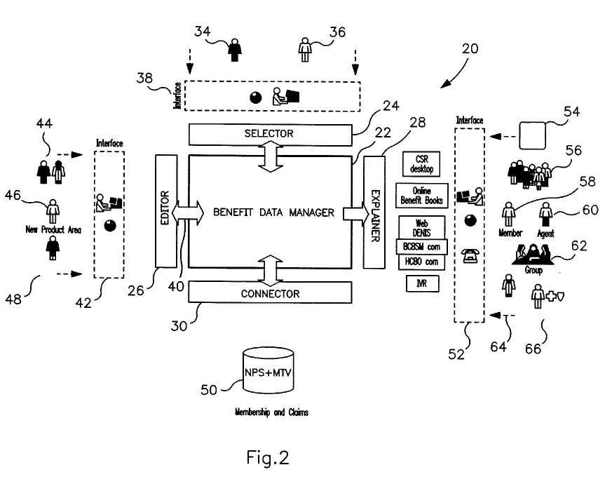

Referring now to the figures, FIG. 1 (and, with more specificity, FIG. 2) illustrates the interaction of the major components of the benefit configurator generally indicated at 20. Benefit configurator 20, as shown, has 5 major components:

A benefit data manager 22 (“BDM”) maintains, controls, and coordinates the creation, usage, and integrity of benefit data, including a consistent data model for benefit information, across all processing systems. A key advantage of BDM 22 is that benefit configurator 20 has a single source for benefit information.

A selector 24 allows a user to view, select, and assemble benefit components into a benefit package per predefined medical, benefit, and payment policies. A key advantage of selector 24 is the streamlined selection of products and benefits for sales agents and brokers or other users allowed access to the system.

An editor 26 is an interface to define and update benefit components and variables for medical, benefit, and payment policies. A key advantage of editor 26 is that it improves accuracy of benefit changes and can dictate or define the components that can be manipulated in Selector 24.

An explainer 28 is a component that dynamically presents easily understandable “read-only” descriptions of benefits available at a current or predefined point in time at both a summary and detail rule level.

A connector 30 is an interface layer to exchange electronic benefit data with a number of external systems such as claims systems. A translator can be a connector that can interface with claims and membership systems. A key advantage is the reduced time for loading new groups. For example, the system can provide periodic uploads on a predetermined basis, such as daily, weekly, and the like, or as needed. External claims systems can include systems connecting external systems, such as those that administer membership benefits and process healthcare claim payments, such as those under the service name NASCO (National Account Services Company LLC, Atlanta, Ga.) to NETEZZA PERFORMANCE SERVER (“NPS”) (Netezza Corporation Framingham Mass.).

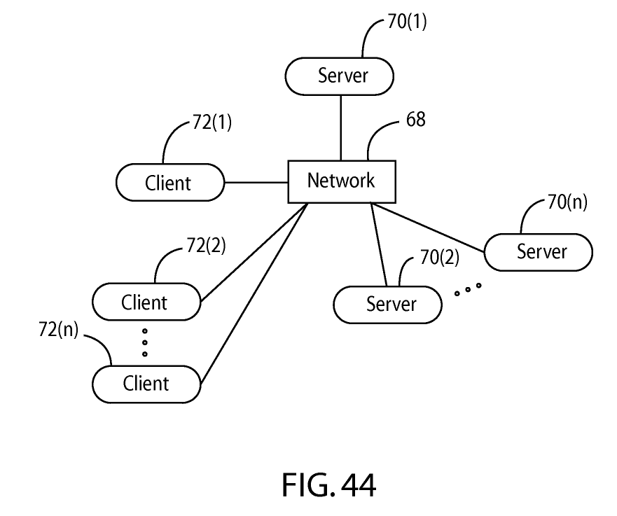

Benefit configurator 20 can allow predefined access levels based on need and security, such as a role-based security model, to ensure user access to data is appropriate. For example, internal staff using the system can use selector 24 to define and assemble new benefit packages and products based upon pre-approved benefit configurations that can be marketed to new groups. Use of editor 26 can be used internally for creating and maintaining rules for benefit policy, payment policy, medical policy, member liability, and other data housed in BDM 22 down to a medical procedure code level. This can include capture of contractual documents. A block diagram showing membership and provider relationships within a benefit configurator environment in one embodiment of the present invention is illustrated in FIG. 44.

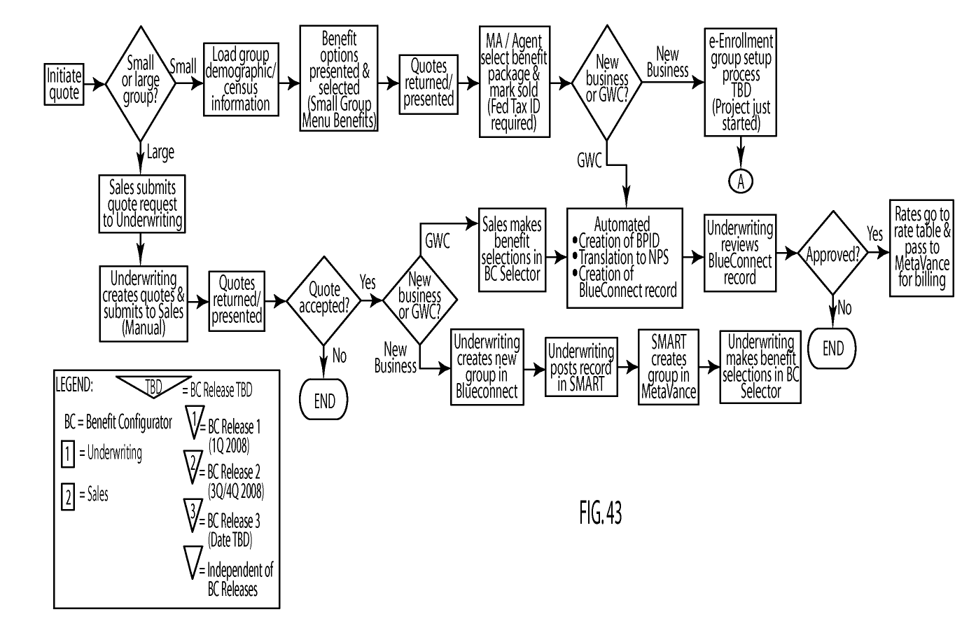

Outside users of the systems can access explainer 28 for real-time (though “read-only”) retrieval of benefit and payment policy data for migrated groups, including data contained in various medical service systems providers, such as assisting payers with proper physician reimbursement (MCKESSON CLAIM CHECK) and pharmacy benefit management (MEDCO and MEDIMPACT). Providers can retrieve benefit data from BDM 22 using various systems such as CAREN IVR, web-DENIS, and BLUE EXCHANGE SYSTEMS. Outside users can see the same benefit data retrieved by internal staff. For illustrative purposes only, FIG. 43 shows a basic data flow diagram of enrollment within the benefit configurator 20 of one embodiment of the present invention.

Automated feed of benefit rules and data to various medical practice management software, such as the MOS (MEDICAL OFFICE SYSTEM) claim system, can eliminate the need for external staff to manually load benefits. Integration of benefit configurator 20 with outside front-end sales tools (e.g., E-QUOTING) allow members, groups, agents, and brokers to select and configure benefit packages.

### Benefit Data Manager (BDM)

Within benefit configurator 20, BDM (Benefit Data Manager) 22 provides a consistent single source data model for benefit information across all processing systems. It allows the host the ability to maintain, control, and coordinate the creation, usage, security, and integrity of benefit data. BDM 22 can consistently and timely capture structured benefit package information, including rules regarding subscriber liability and covered services and associated carve-outs, limitations and maximums, down to the procedure code level of detail. BMD 22 allows for a structured benefit model with a cross-reference index to allow proper translations to processing systems outside of the benefit configurator 20.

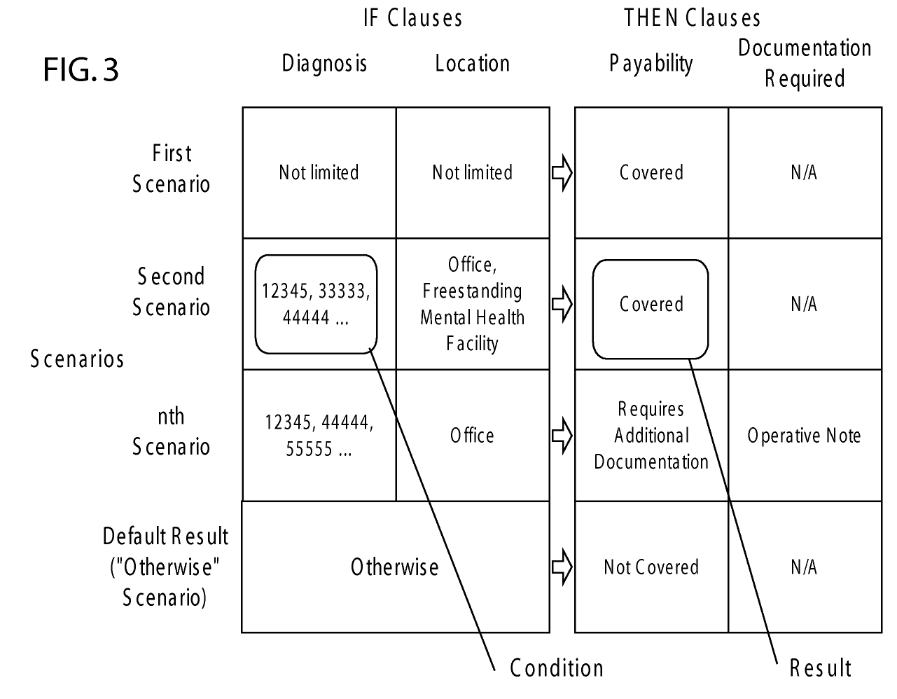

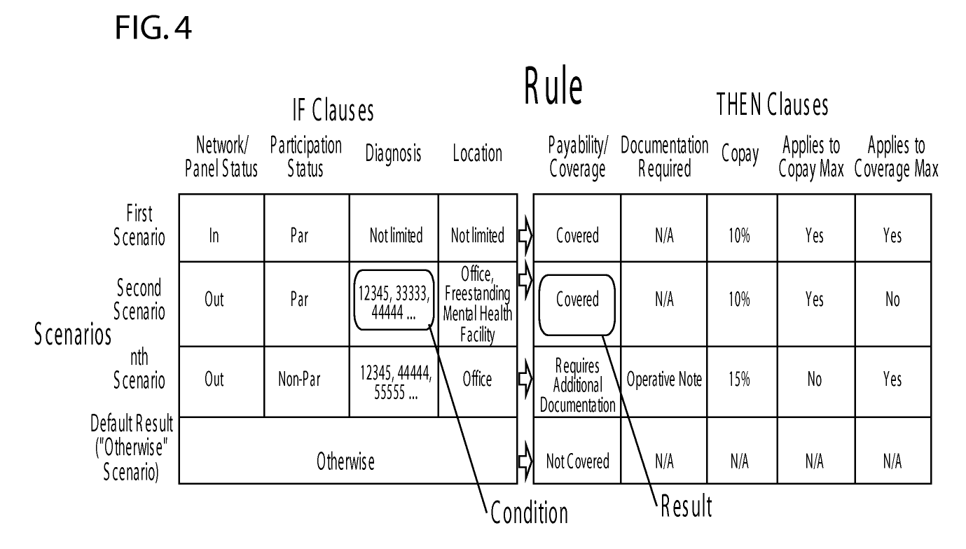

BDM 22 is a complete centralized source for all benefit rule data. Such data can be developed within a relational database, such as one provided under the name ORACLE (Oracle International Corporation, Redwood City Calif.). Any benefit rules that explain how a claim might be treated must be reflected in BDM 20. All maintenance of benefit rule data will be managed solely with BDM 20. In the present context, a rule is a predetermined medical policy to determine the outcome of a specific inquiry by a subscriber or user of the system. BDM 22 is the data repository for benefit-related data and documentation to be accessed by all stakeholders having access to the system at all levels. In one embodiment, BDM 22 is centered around a Benefit Topic Tree, which is a network of benefit topics that represents a benefits structure (See FIGS. 3 and 4). FIG. 3 serves as the foundation BDM 22. Each topic can have one or more sub (“child”) topics, with the lowest level being procedure codes. Each topic node can have zero or many rules that specify the conditions under which the benefit is covered or payable. These rules represent the medical policy. As such, benefit rules are used to explicitly define the coverage status for a benefit. For example, a rule can define whether a particular procedure or topic is payable or not payable because it is considered by the rule to be investigational or cosmetic. An advantage of the present invention is the ease with which standard medical policy can be automatically overwritten with contractual variation through the normal maintenance of rules associated with appropriate documents that are later combined into a product and ultimately a package.

BDM 22 components or modules can include Benefit Package Components (BPCs). BPCs can be a collection of benefit rules that reflects the implementation of a Source Document. These modular components can be assembled into Product offerings. A Certificate, Rider, or ASC Plan Mod [Approved Service Center Plan Modifications??] would be considered a separate BPC. Products can be essentially a collection of BPCs (and the associated rules that define the interaction between them) that reflects a single entity that can be offered for sale. Benefit Packages can be a unique collection of one or more Products that can be sold as a unit. A Benefit Package can contain more than one line of business. Other insurance services, such as policies related to life, home, auto, and disability, are also based on complex relationships and rules. Multiple services and related industries, including investment management, commodities, and stock brokerages, financial management services such as those related to banking, and legal services provide uniquely tailored services that depend on a number of static and dynamic factors and considerations. As such, use of the present invention is envisioned for use within these business lines.

BDM 22 should support subscribers billed individually and groups that have, for example, a standard benefit package from the local menu. A successful data model can be developed to support the target final state and must ensure that complete and correct source documents that justify a given policy are properly linked and related within the BDM 22. In use, BDM 22 data model and repository must achieve tight integration with front-end sales tools used in the art.

### Selector

Selector 24 is another key component of benefit configurator 20 as a presentation layer that provides the ability to view, select, and assemble into a benefit package per policy rules and definitions. Selector 24 is communicatively connected (e.g., through the Internet, local area network, wide area network, and the like) to BDM 22 at connection 32. In the present context, such communications between and among the components are well known in the art. Selector 24 is configured to guide a user through the process by only allowing pre-approved benefit configurations based on a set of rules determined by the size, type, and other criteria of the customer that the benefit package is being configured for. In use, selector 22 allows a user to view, select, and assemble benefit components from BDM 22 into a benefit package per predefined medical, benefit, and payment policies. Users can include host sales manager, marketers, and agents 34 or predefined/predetermined individual member group representative 36. Users may interface with selector 24 via interface 38, which can be a computer terminal or the like. A key advantage of selector 24 is the streamlined selection of products and benefits for sales agents and brokers or other users allowed access to the system.

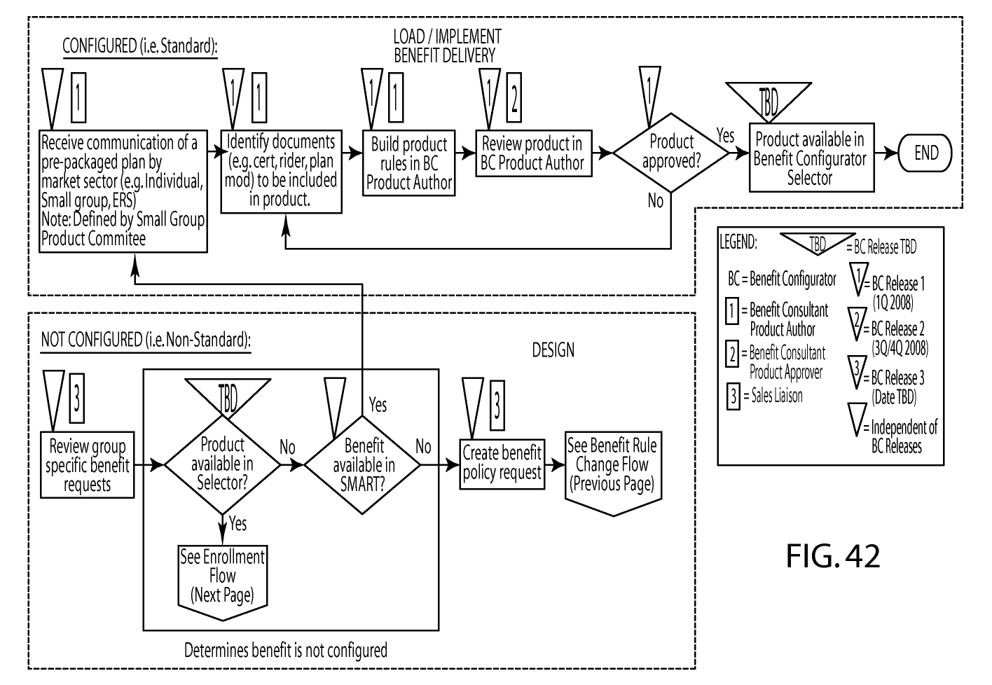

Selector 24 is configured to guide a user/stakeholder through the process by only allowing pre-approved benefit configurations based on a set of rules determined by the size, type, and other criteria of the customer for which the benefit package is being configured. For illustration purposes only, FIG. 42 shows a data flow diagram of product selection of the selector of one embodiment of the present invention. Once a selection of benefits has been configured, benefit package forms numbers within BDM 22 can be sent to a rating engine and generate benefit package rates to display to the user via selector 24. When the user is satisfied with the benefit package, selector 24 can then update the information in BDM 24 and send required data to other systems as needed or predetermined.

Selector 24 architecture should support component-based development of multi-tier enterprise applications. Such architecture can include a JAVA 2 Platform, Enterprise Edition (J2EE) (Sun Microsystems, Inc., Santa Clara, Calif.), for developing multi-tier enterprise services. Integration with other industry packages, such as eQuoting and BlueConnect of Blue Cross and Blue Shield of Michigan, can also be incorporated. In any instance, the system is configured to allow only properly defined products to be selected for a benefit package.

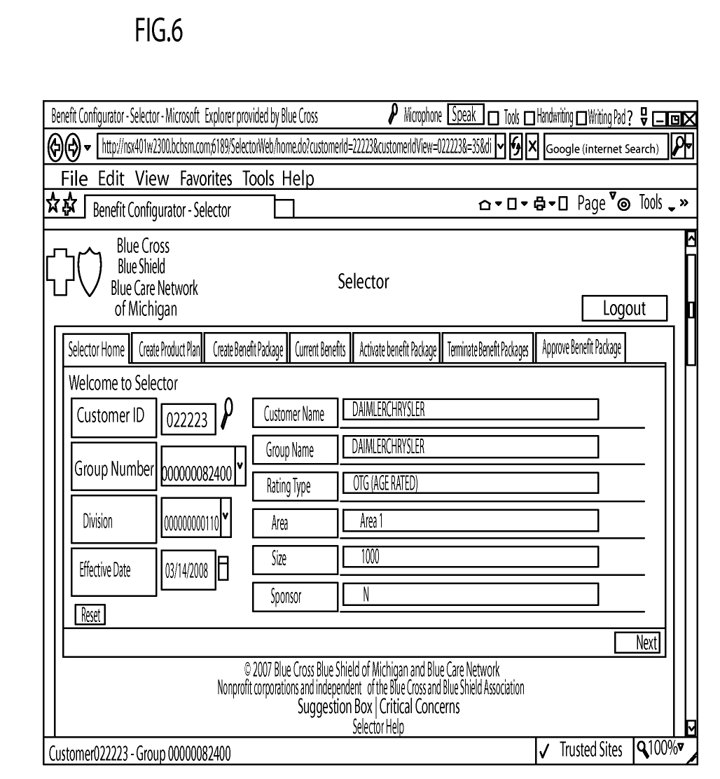

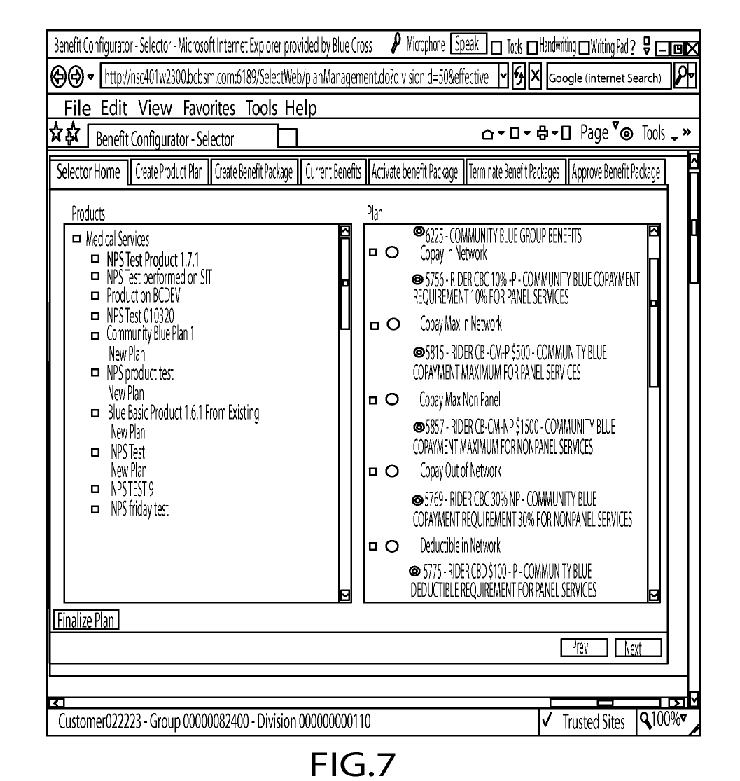

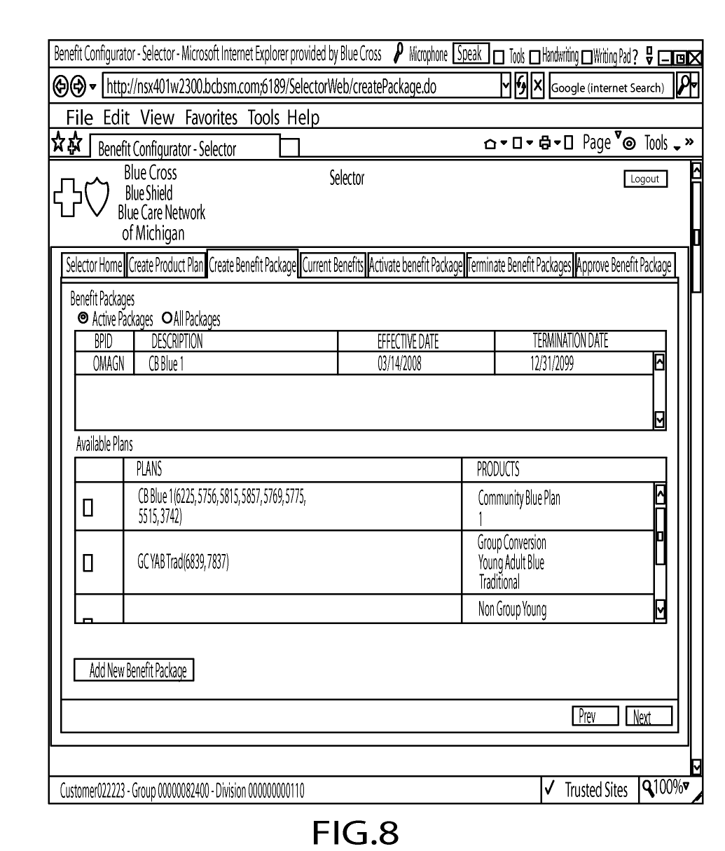

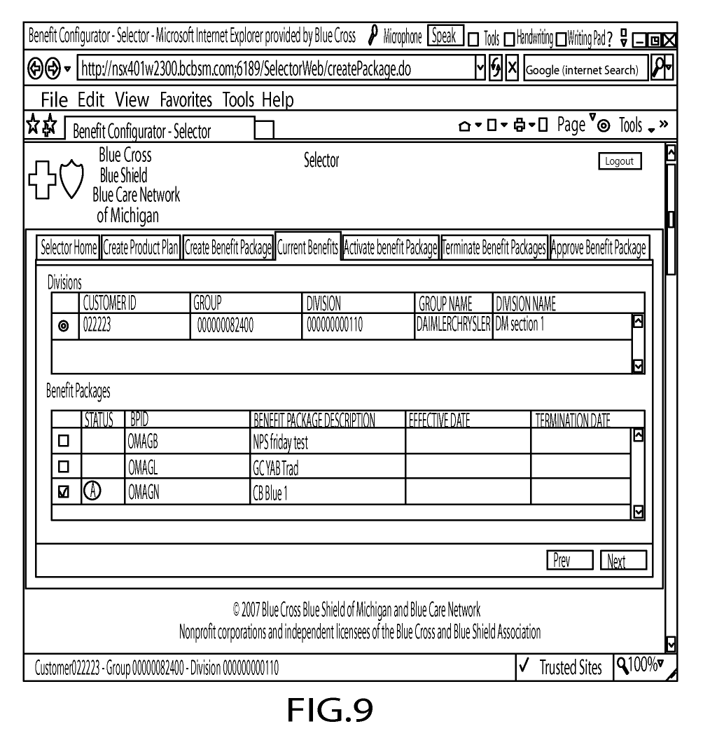

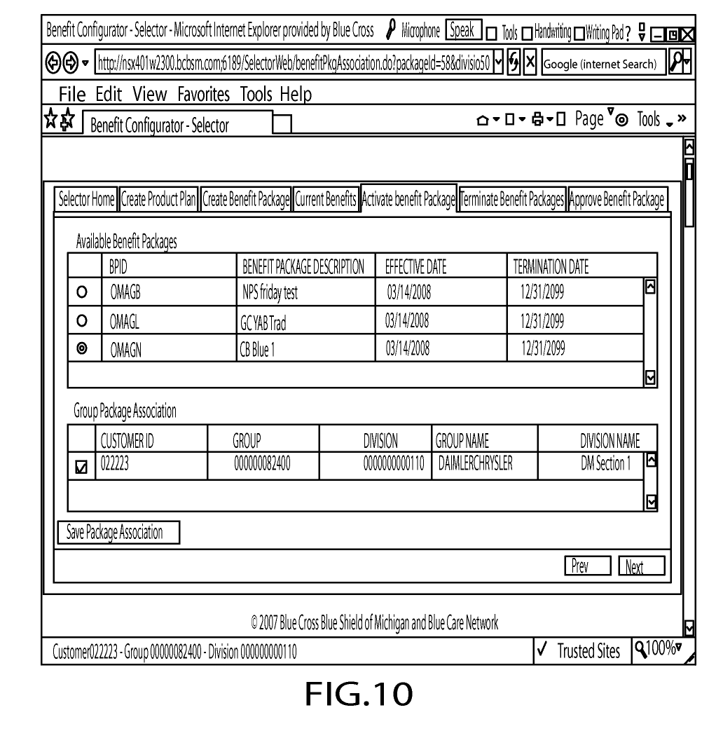

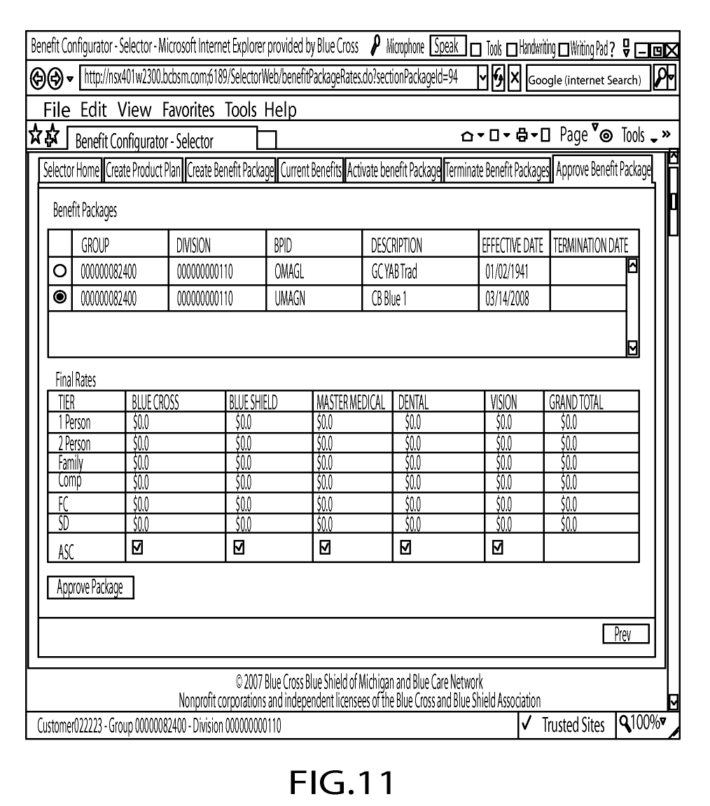

FIGS. 6-11 show diagrams of an interface that could be used to allow a user to move through the various functions of a selector having features to create product plans, create benefit packages, show current benefits, activate benefit packages, terminate benefit packages, and approve benefit packages. As shown, selector 24 can be configured as a sequence of tabs for a user to move through to create a benefit package.

### Editor

Editor 26, as a topic maintenance tool, is another key component of benefit configurator 20 and is communicatively connected (e.g., through the Internet, local area network, wide area network, and the like) to BDM 22 at connection 40. Editor 26 is the primary application of benefit configurator 20 for maintaining the data quality of a substantial portion of BDM 22. As such, editor 26 is a most critical component of benefit configurator 20. Content to be maintained can include: benefit topic hierarchy, structured definition of medical, payment and benefit policy in the form of rules, structured definition of products in the form of rules that are available for use by selector 24; structured definition of benefits package components, including rules, that have been configured by selector 24; and for each rule, links to supporting documentation stored within BDM 22.

Editor 26 allows those with access the ability to define and update benefit components and variables for benefit and payment policies and the like. Tools can be provided within editor 26 to allow mass changes or system-wide changes. A key advantage of editor 26 is that it improves accuracy of benefit changes. Access to BDM 22 via editor 26 should be restricted to only specific users to ensure integrity of the system. As shown in FIG. 2, such access, via editor interface 42, can be limited to users involved in medical affairs 44, new products 46, and regulatory affairs 48.

Editor 26 is thus a suite of tools used to create and maintain content within the BDM 22. For example, in one embodiment, editor 26 can support several business functions. It can be used to create and maintain product and benefit package definitions, including the underlying benefit policy, member liability, and payment policy rules. It can be configured to create and maintain multiple representations of benefits to support satellite reporting systems (e.g., CAREN, YBG, and the like). It can also support multiple approaches to how products are defined and represented while maintaining the underlying structured content within the BDM 22 rule model, as well as support the configuration of benefit packages for use within Selector 24. Additionally, editor 26 can represent the net effects of medical policy, benefit policy, and member liability rules at a procedure code level and support: automatic updates to claims processing systems, such the NPS benefit code in the Nasco claims processing system (described below and shown at 50 on FIG. 2); manual coding of NPS benefit code logic when the existing BDM rule model cannot represent a benefit; and managing BDM 22 rule status and creation of model office NPS benefit code.

In use, editor 26 can support creating product definitions for any customer using a local menu and direct bill to configure benefits. It can also support new benefit policy and member liability rule types as well as: support product/benefit package BDM 22 rule inheritance; create tools to migrate existing product/benefit package content; support simple benefit configurator 20 Selector 24 tools; supports NPS Model Office test/production capability; and provide a multi-control plan support in the form of separate instances of databases.

Editor 26 is designed with flexibility to add additional benefit policy, member liability rule types as needed to support product and benefit package definitions on an ongoing basis. This includes integration with workflow technologies for product/benefit package creation and medical policy updates. Editor 26 can also allow editing of the benefit configurator 20 benefit topic tree described above and shown in FIGS. 3 and 4.

Editor 26 can be configured to represent all benefits for a benefit package in BDM's 22 rule format. Minimal manual coding of BDM 22 rules is necessary to auto-load NPS benefit code. Editor 26 is designed to be easy to use, such that benefit design analysts can efficiently configure products and benefit package components.

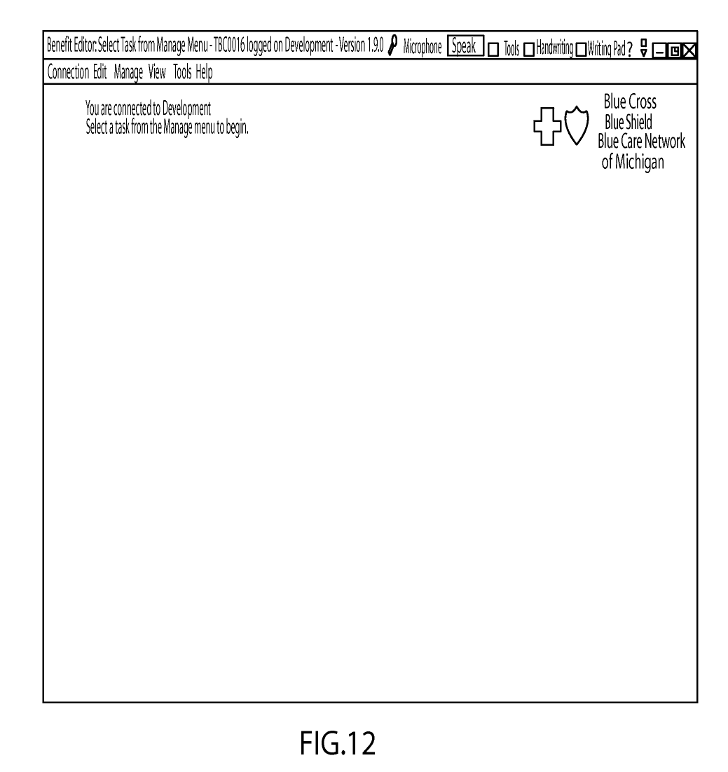

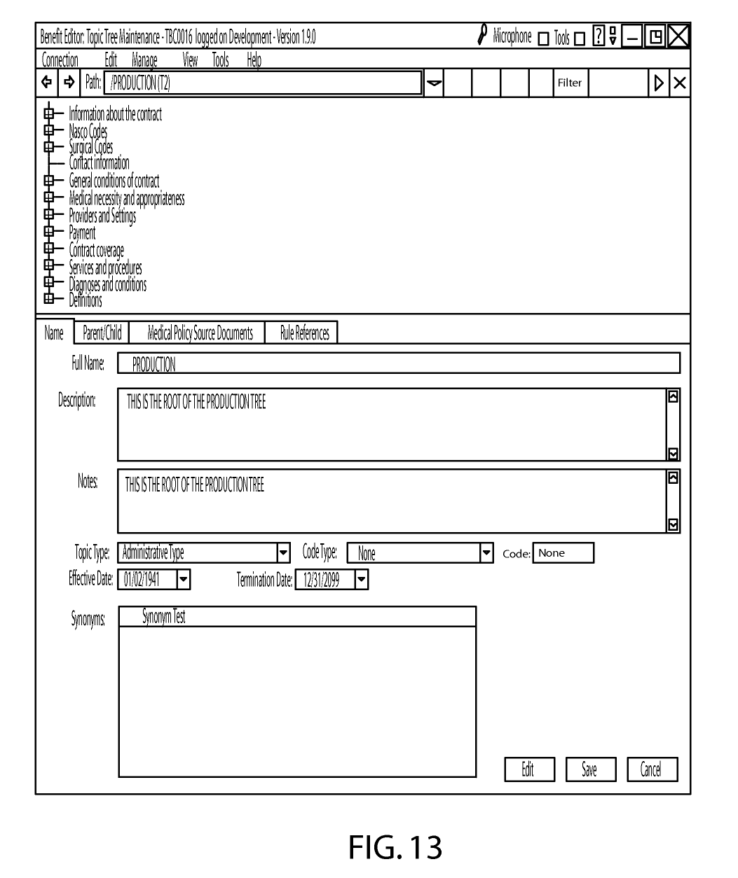

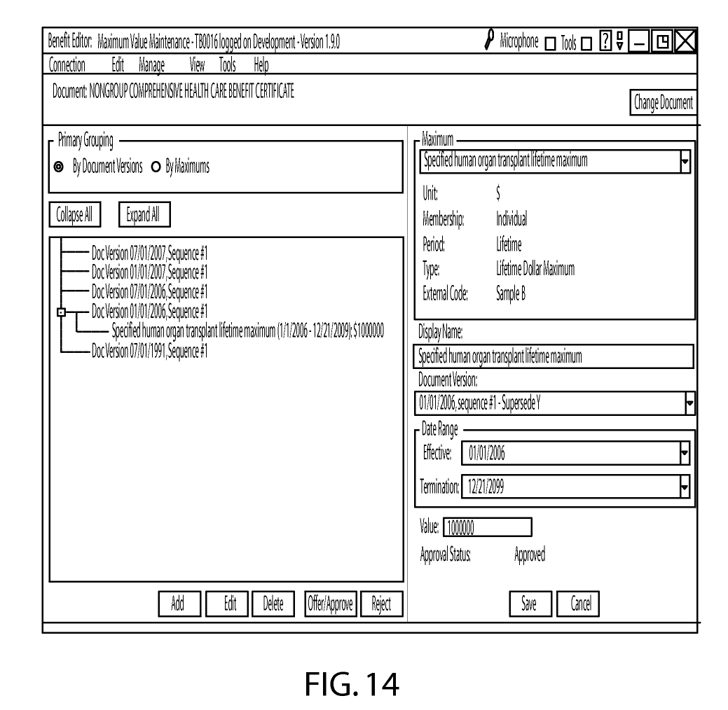

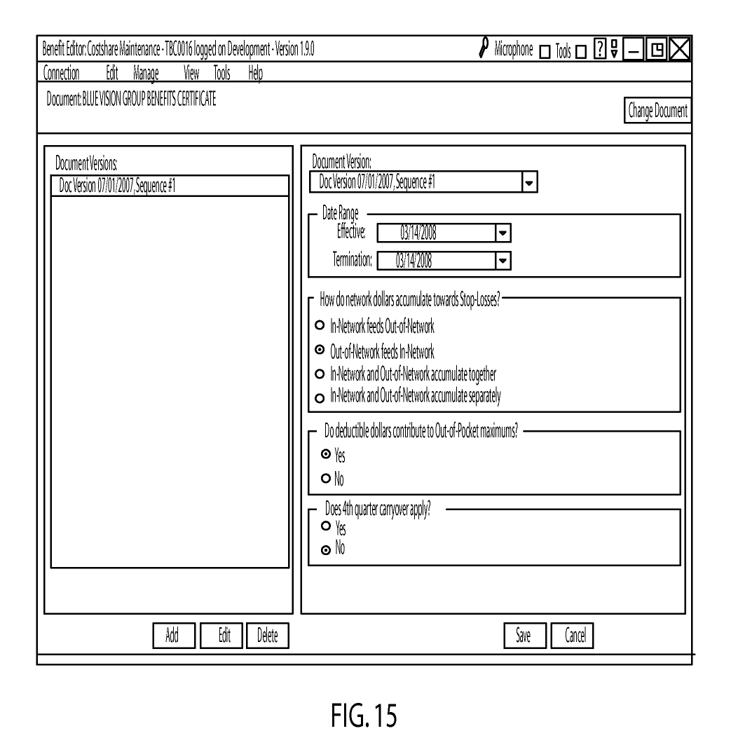

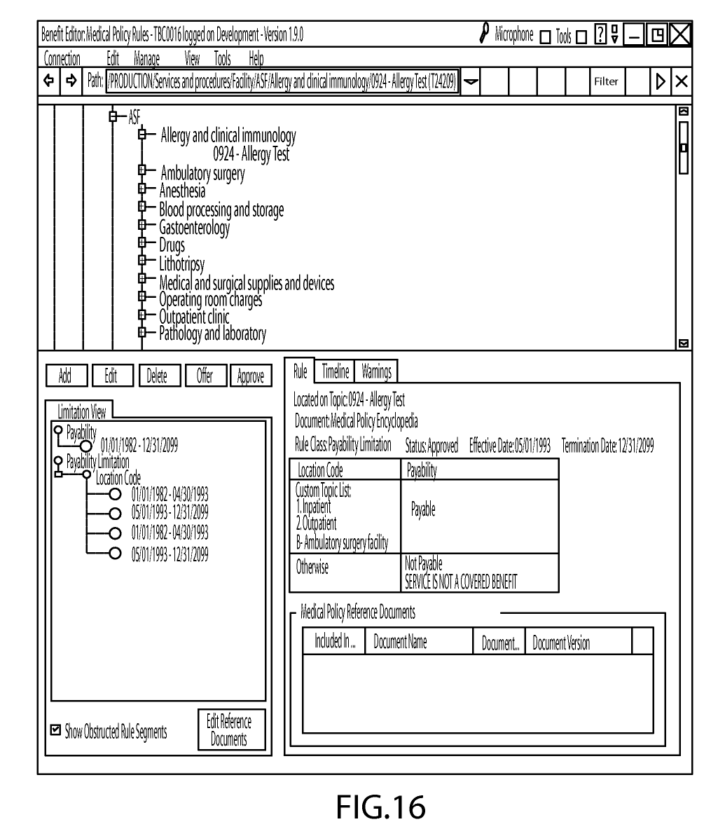

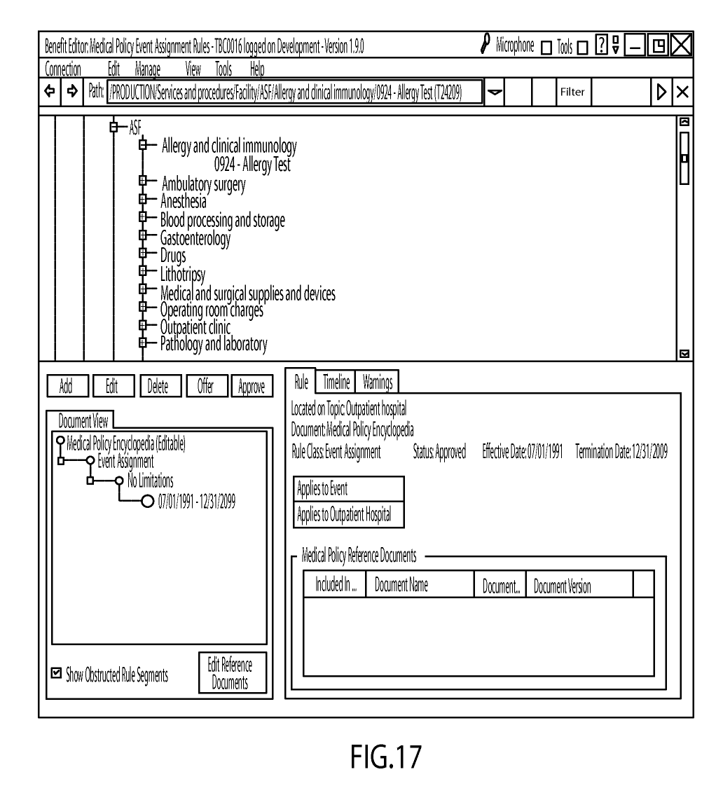

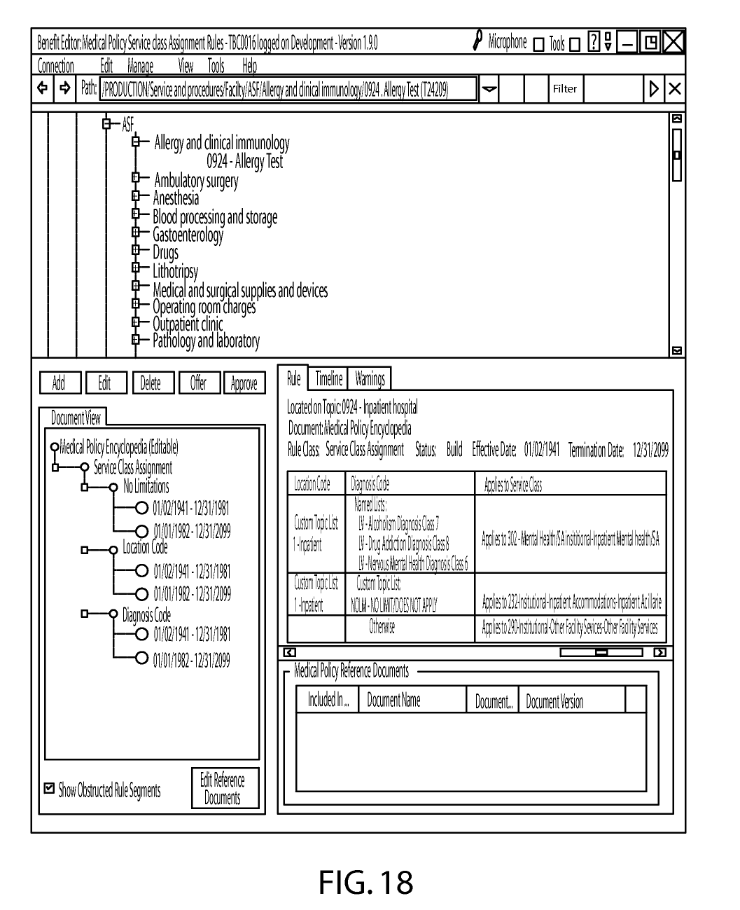

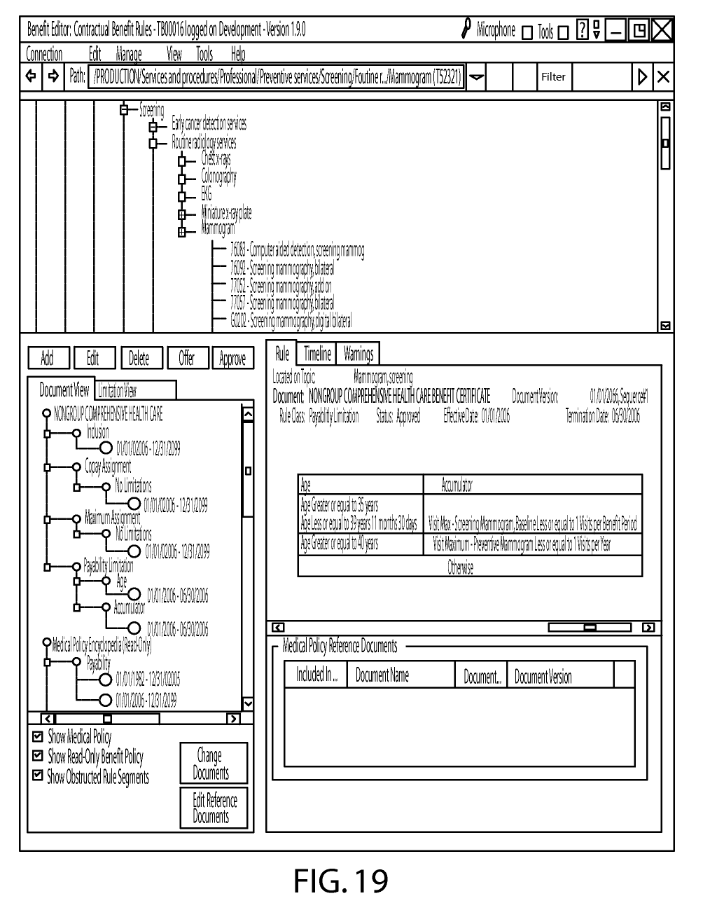

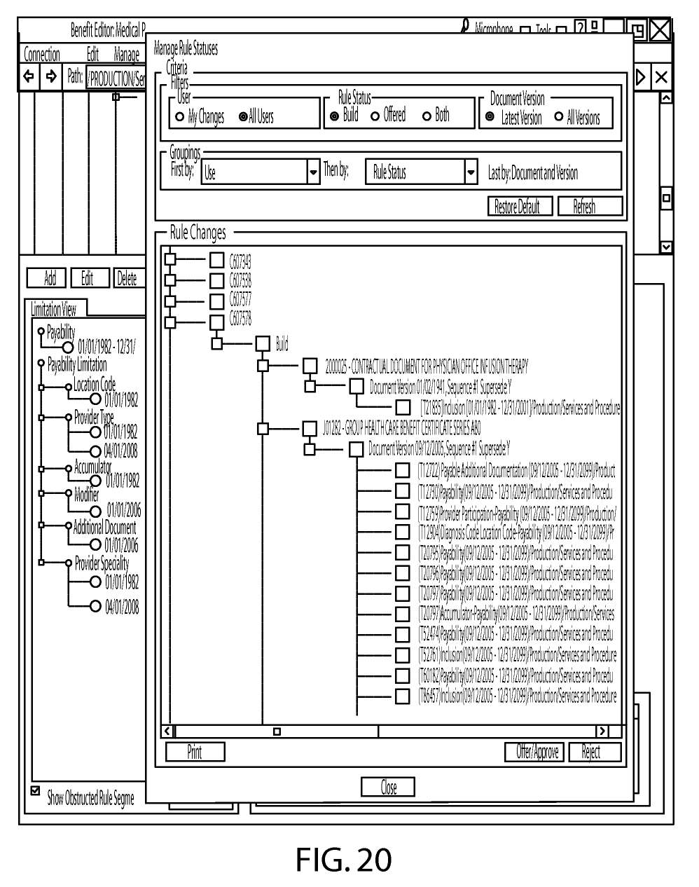

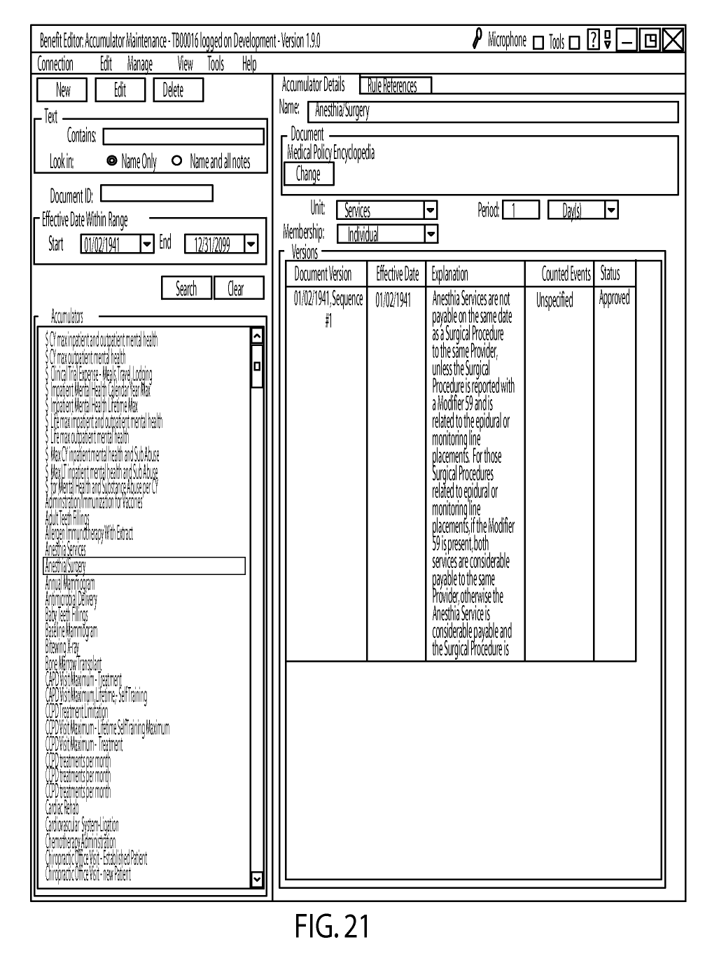

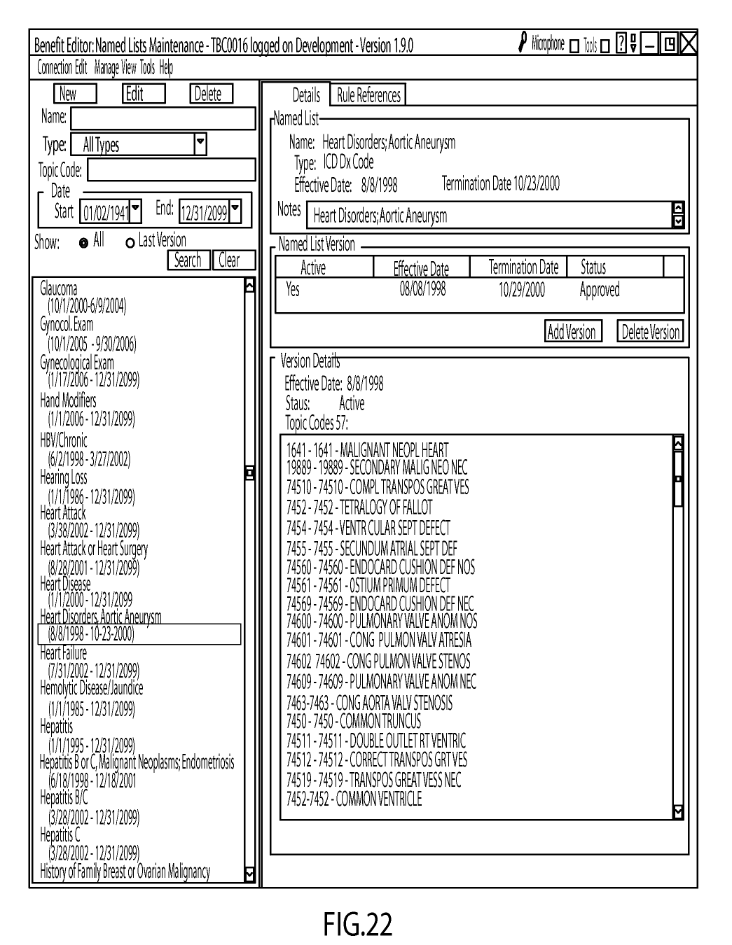

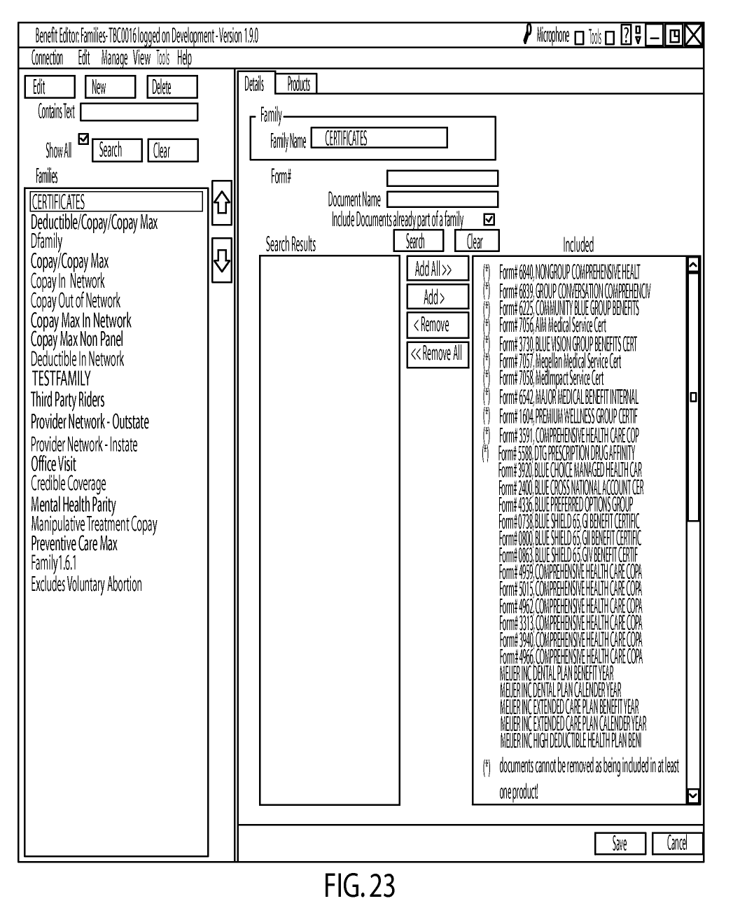

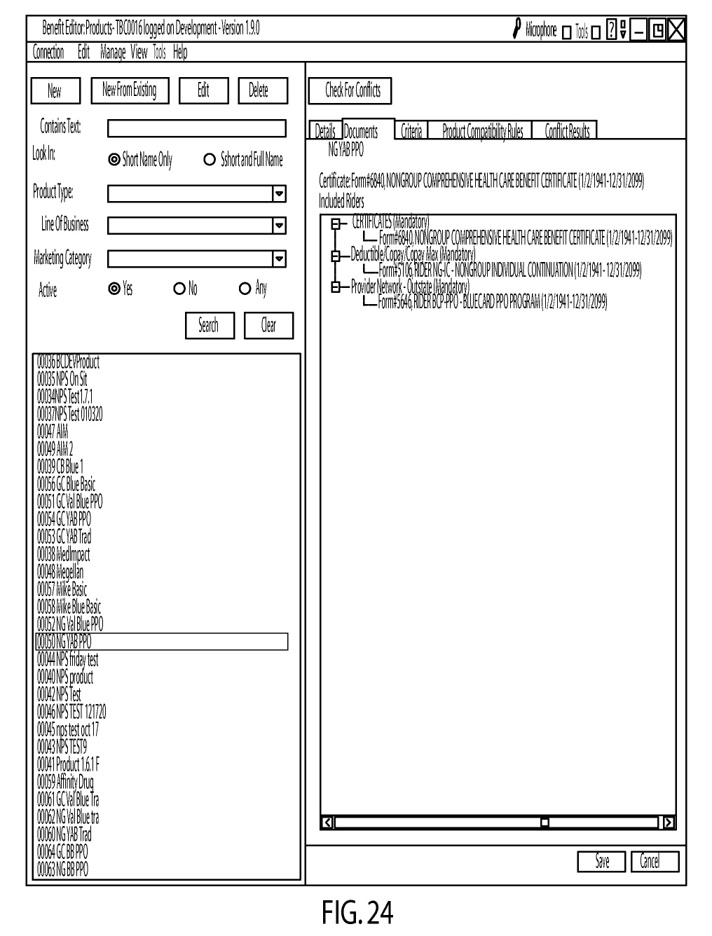

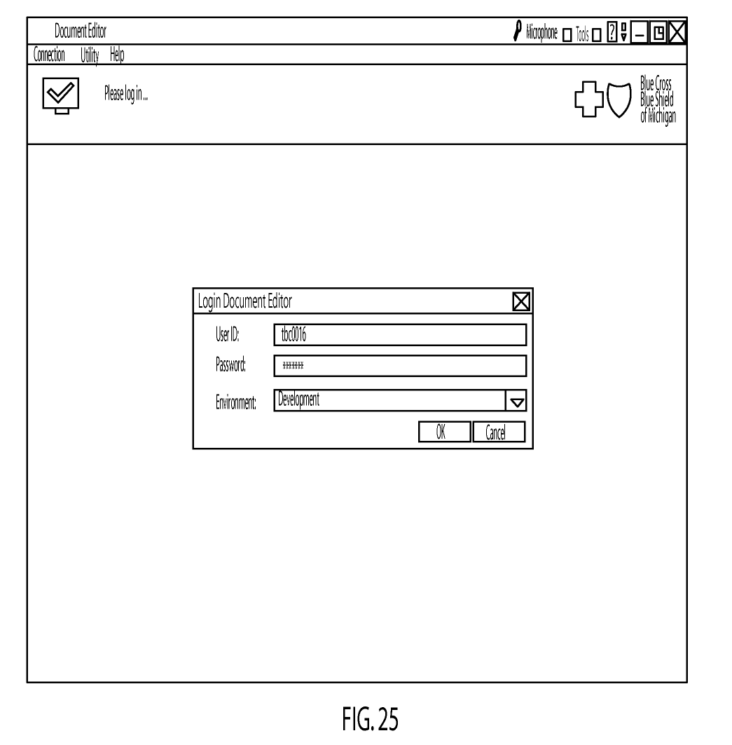

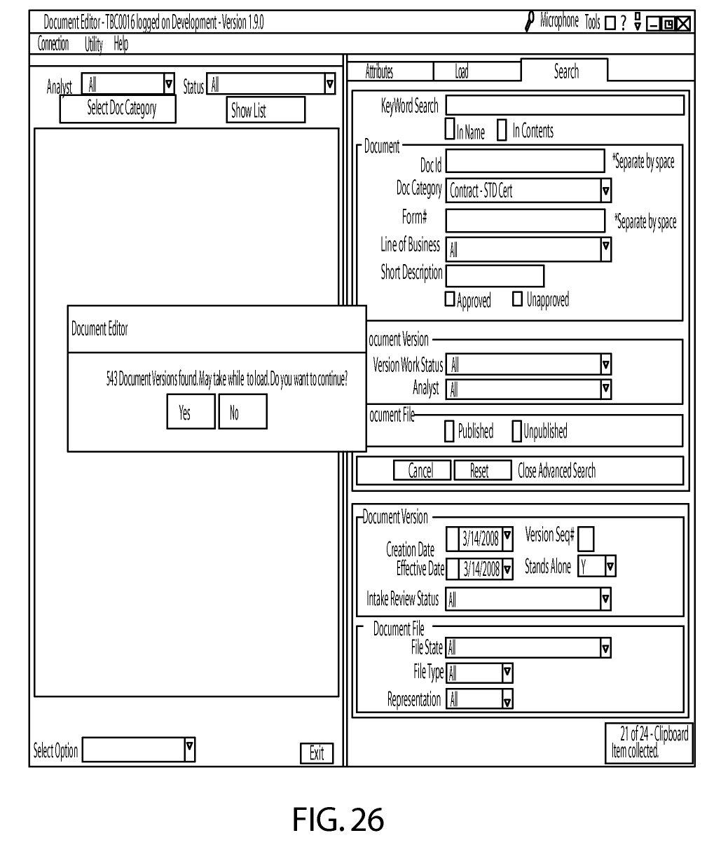

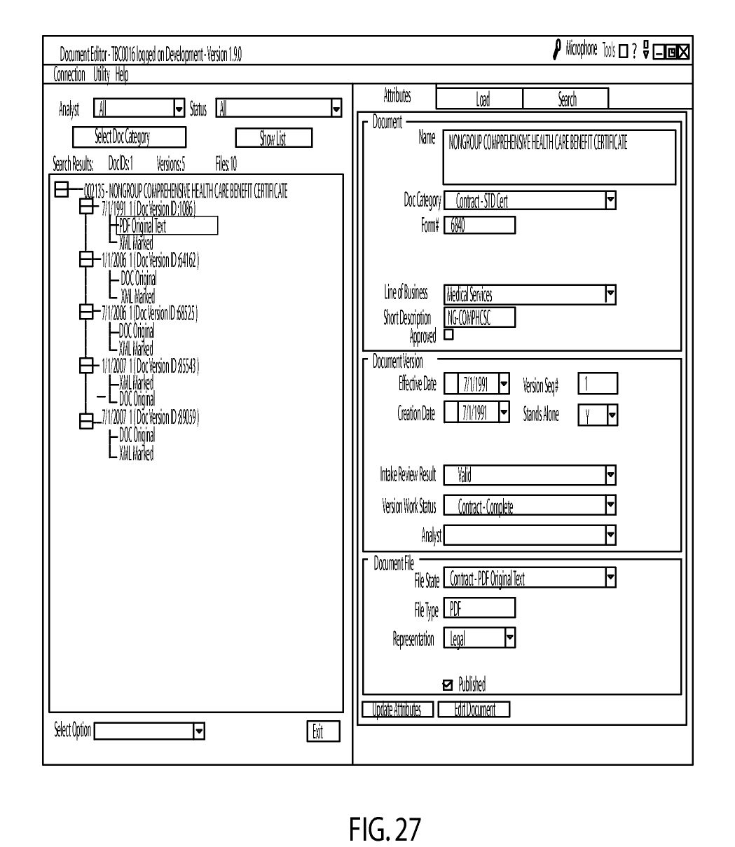

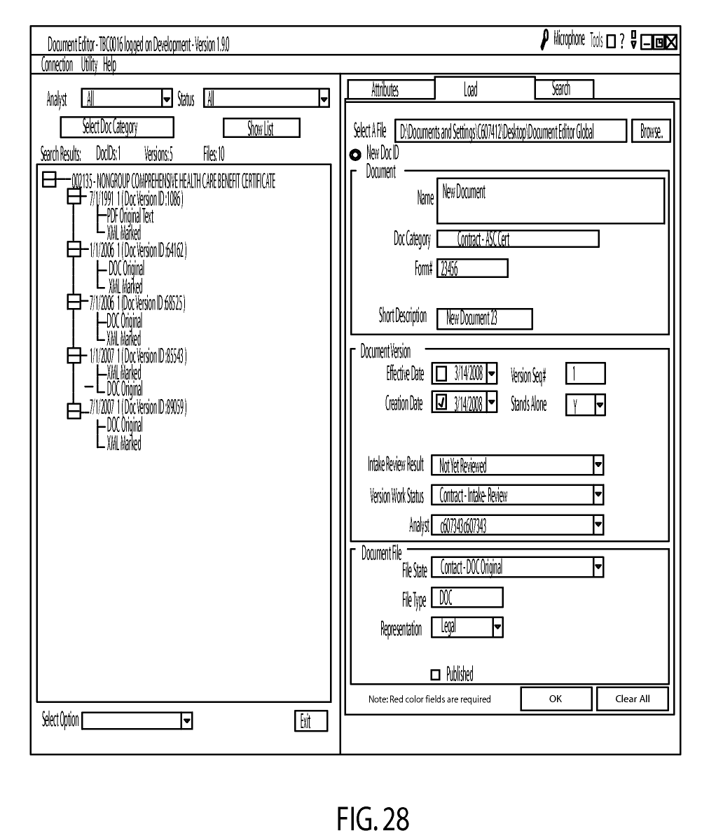

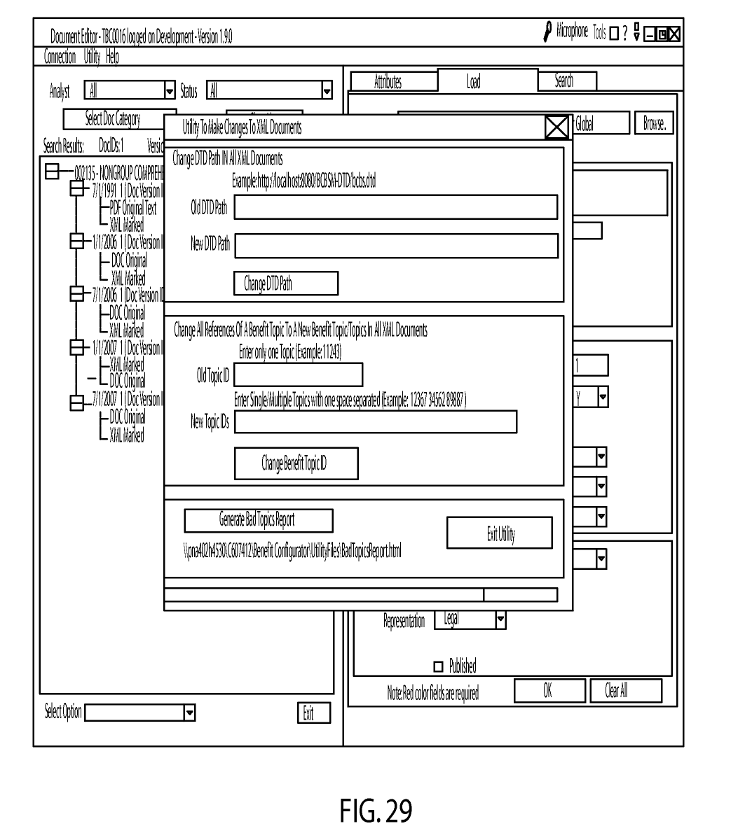

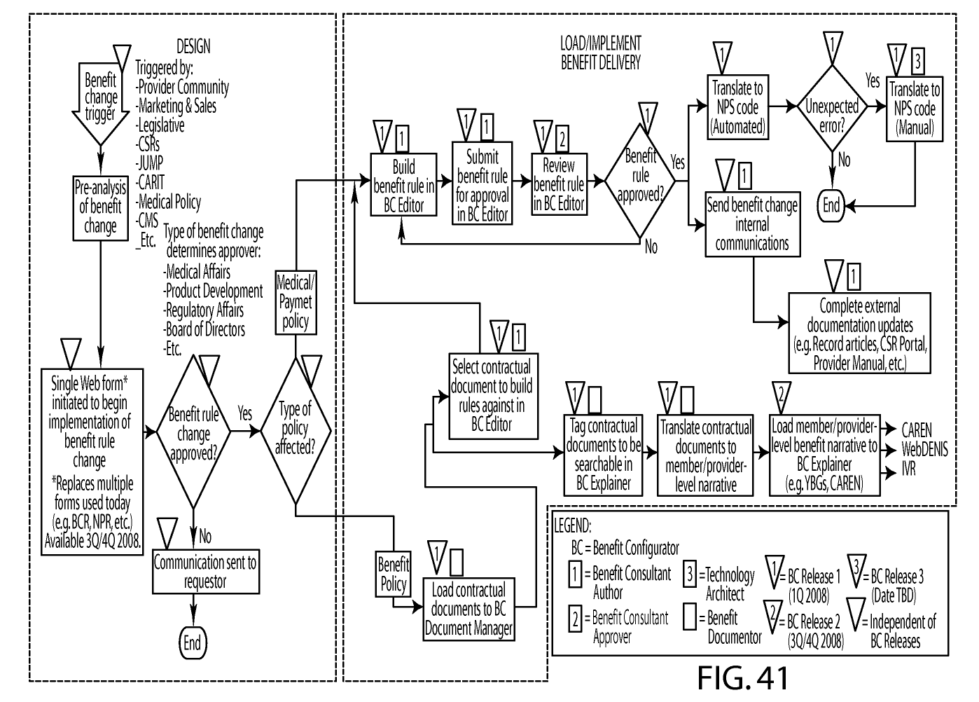

In short, editor 26 allows a limited and predefined set of users to adjust and modify the benefit configurator 20 to allow flexibility and change to a dynamic benefit data manager 22 while maintaining system integrity and accuracy. FIG. 41 illustrates a data flow diagram of an initiation and implementation of a benefit rule change of the editor of one embodiment of the present invention. FIGS. 12-24 show diagrams of an interface that could be used to allow a user to move through the various functions of an editor for various benefits. FIGS. 25-29 show diagrams of interfaces that could be used to allow a user to move through the various functions of an editor for various documents.

### Explainer

The explainer 28 is another presentation layer component of benefit configurator 20 and builds easily understandable “read-only” descriptions of benefits available at a current or predefined point in time at both a summary and detail rule level to a large variety of potential users. Quick search and advanced search capabilities can be provided to support different user needs using graphic user interfaces (GUIs) to facilitate easy navigation or other types of enhanced views of account benefits.

Access to explainer 28 can be through an explainer interface 52, which can include a computer terminal, telephone, and the like. Users that can access explainer 28 can be role-based and, as shown in FIG. 2, can include individuals associated with customer/provider/agent service reps 54, host members 56, plan members 58, plan agents 60, groups 62, service providers 64, plan providers 66, and the like.

Explainer 28 can support an enhanced view of benefit package details and provide users enhanced search capabilities. Benefit detail record (BDR) and non-BDR documents can be generated in real time as a result of user request. Benefit configurator can support provider 64 host system information to providers (such as Web DENIS of Blue Cross and Blue Shield of Michigan) for providers to view migrated member and group benefit package details. Explainer 28 can also use a J2EE architecture.

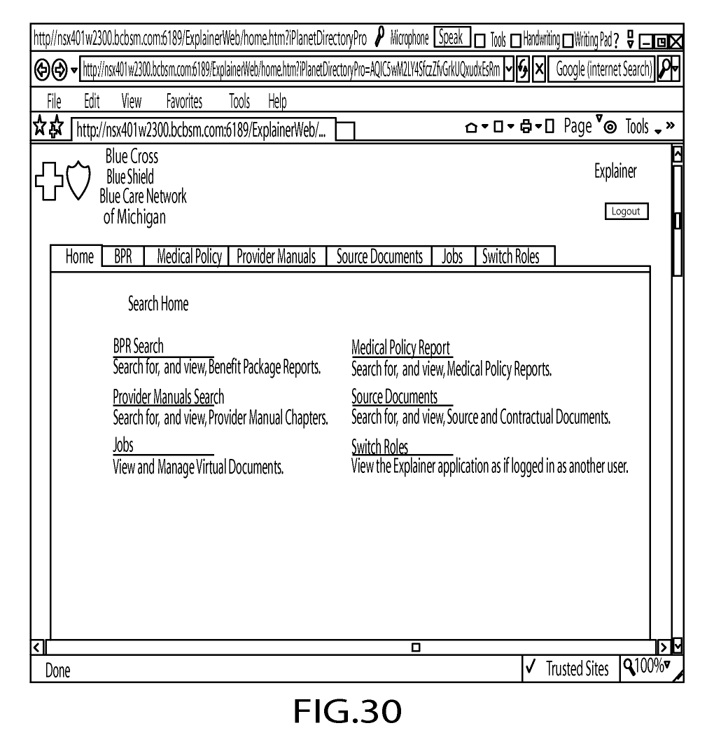

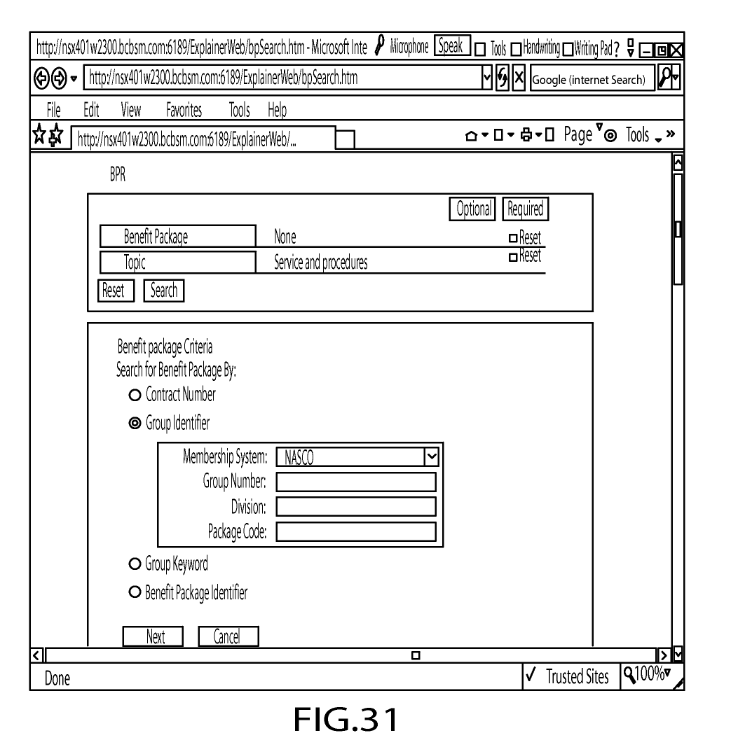

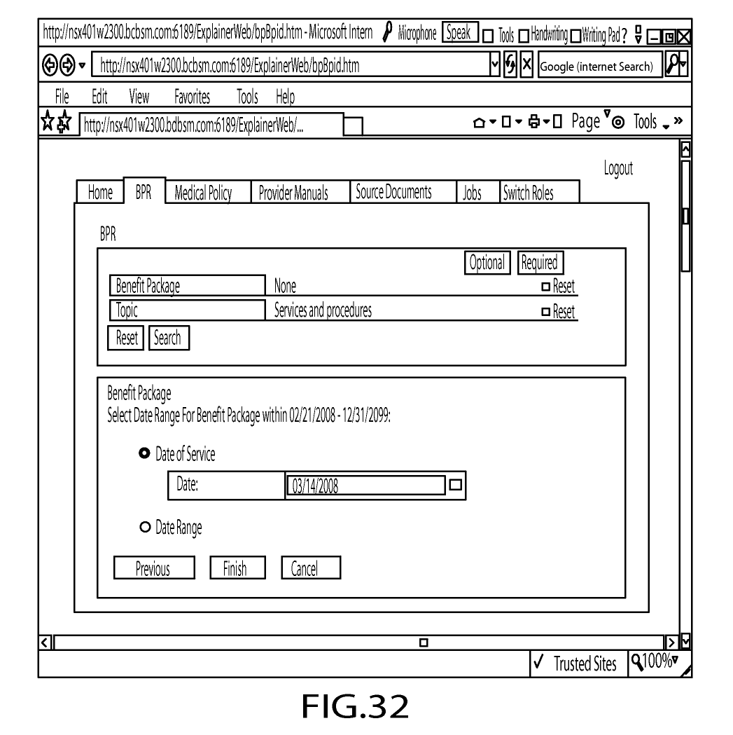

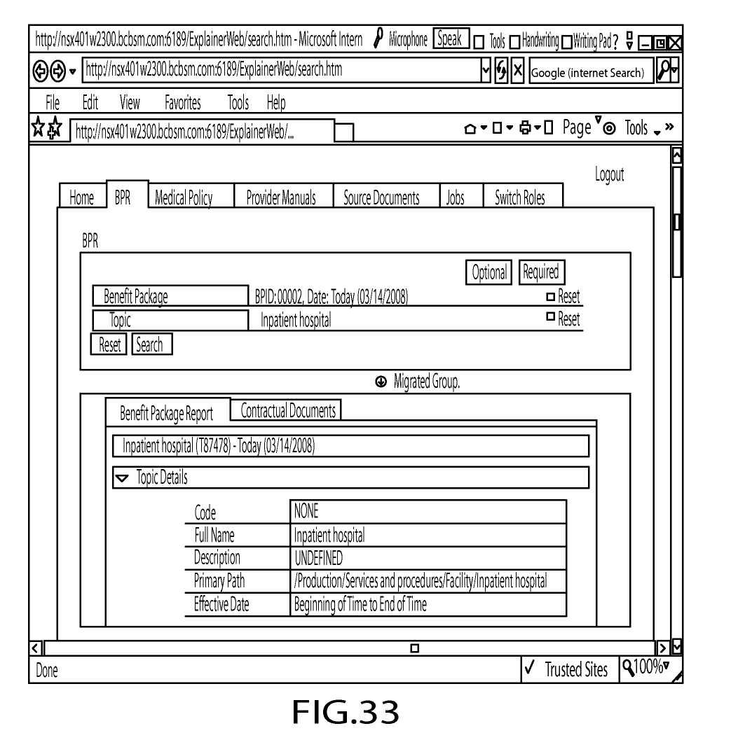

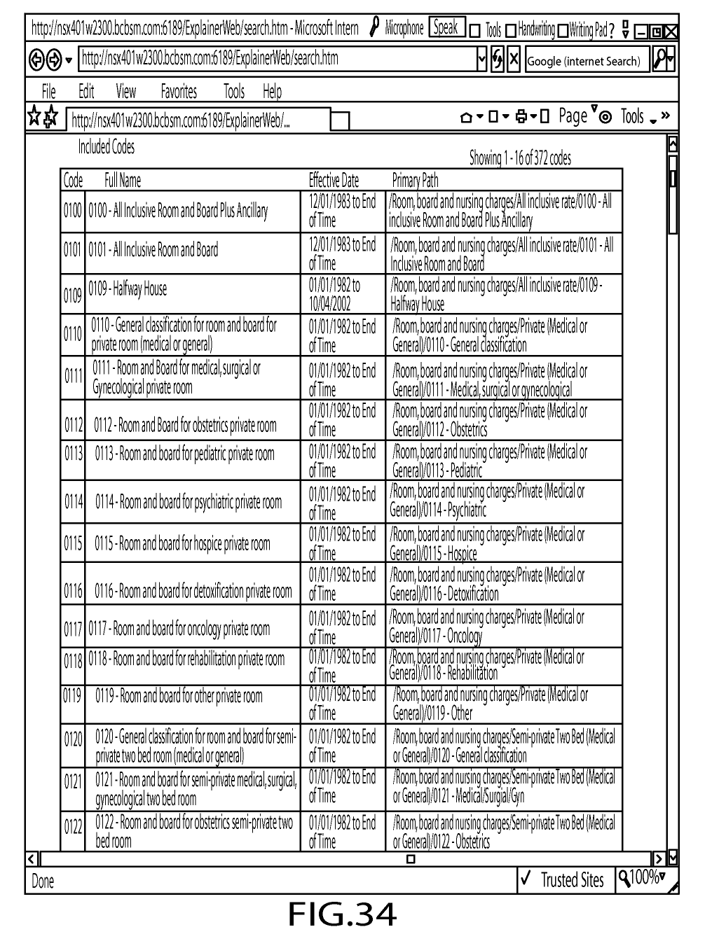

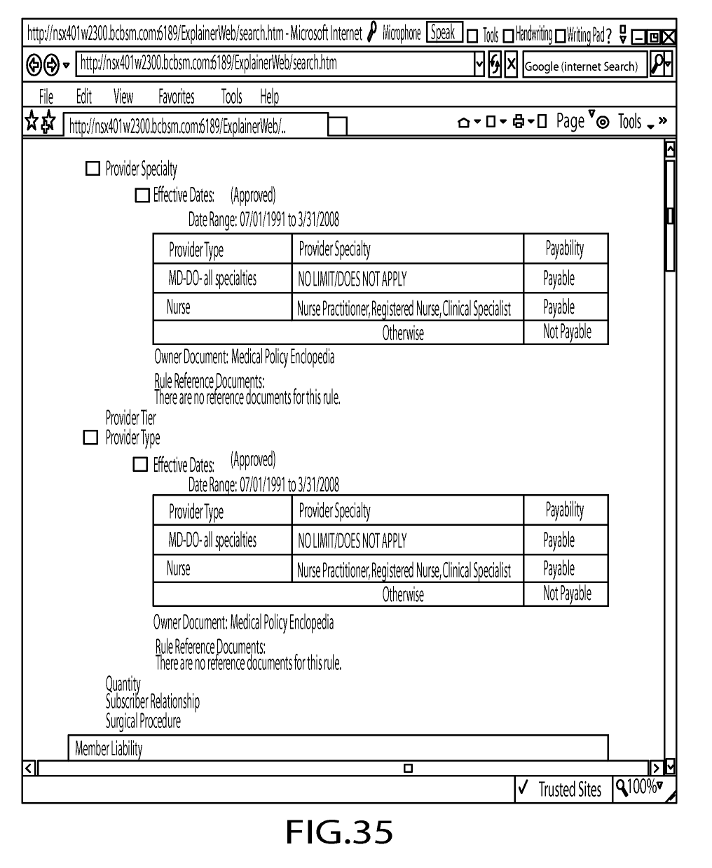

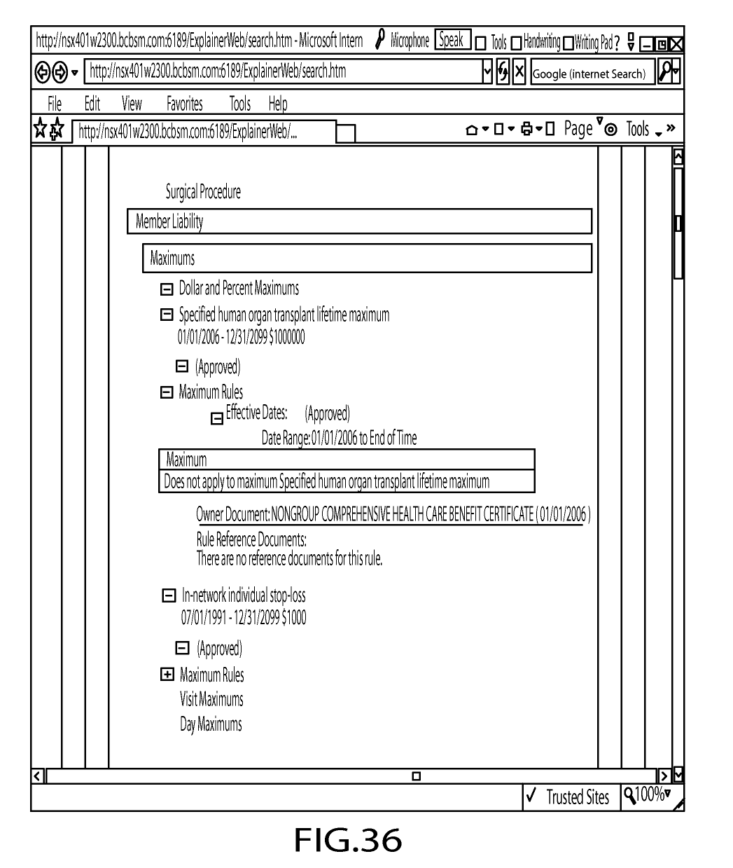

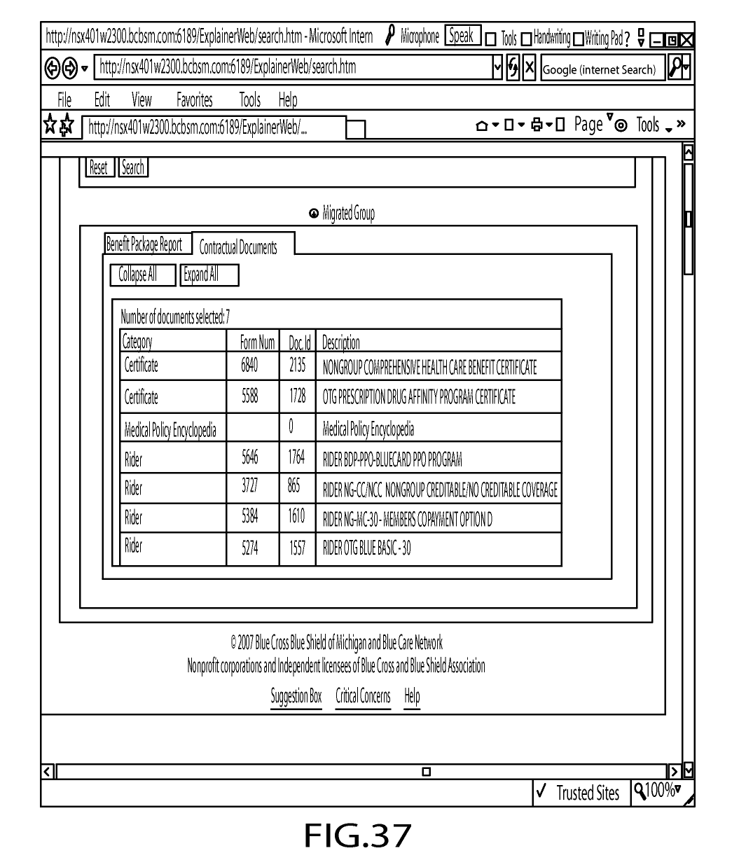

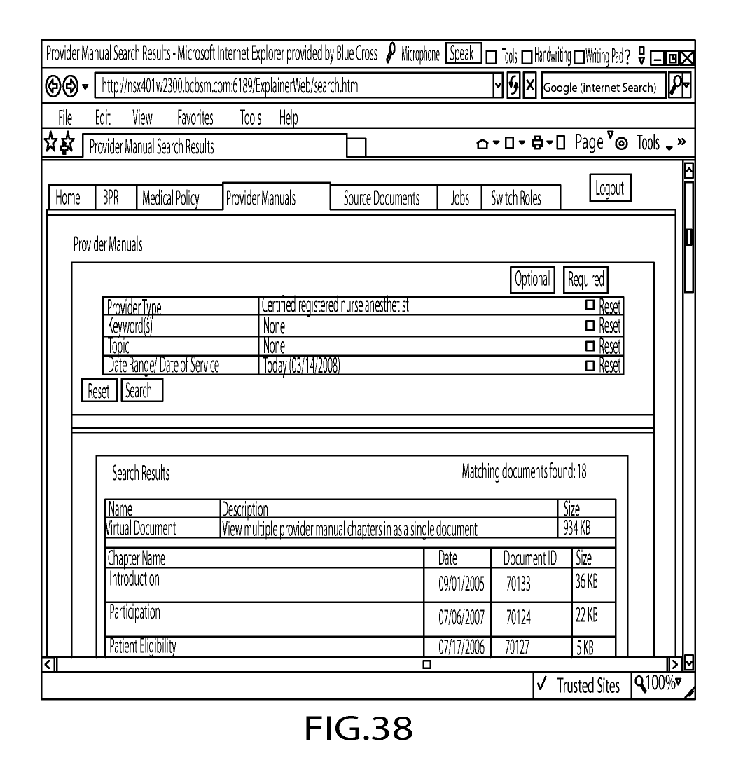

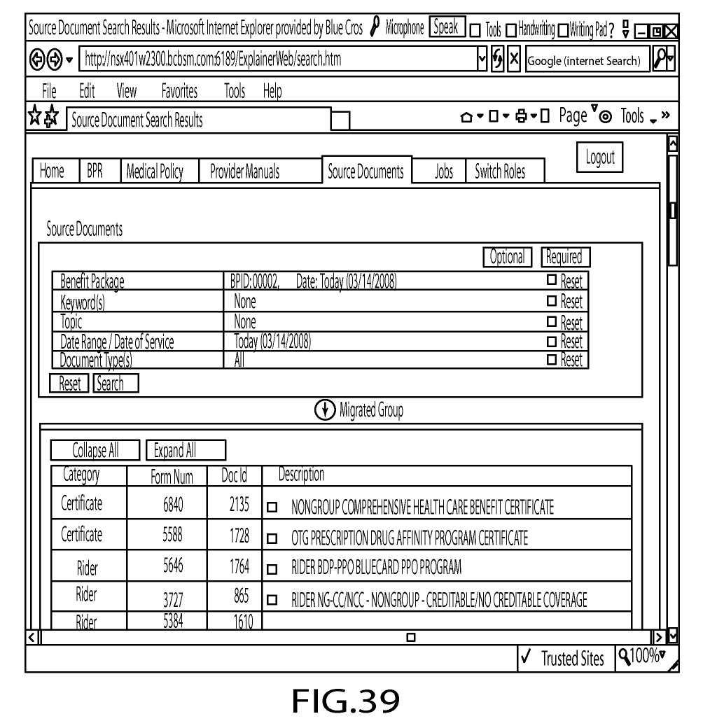

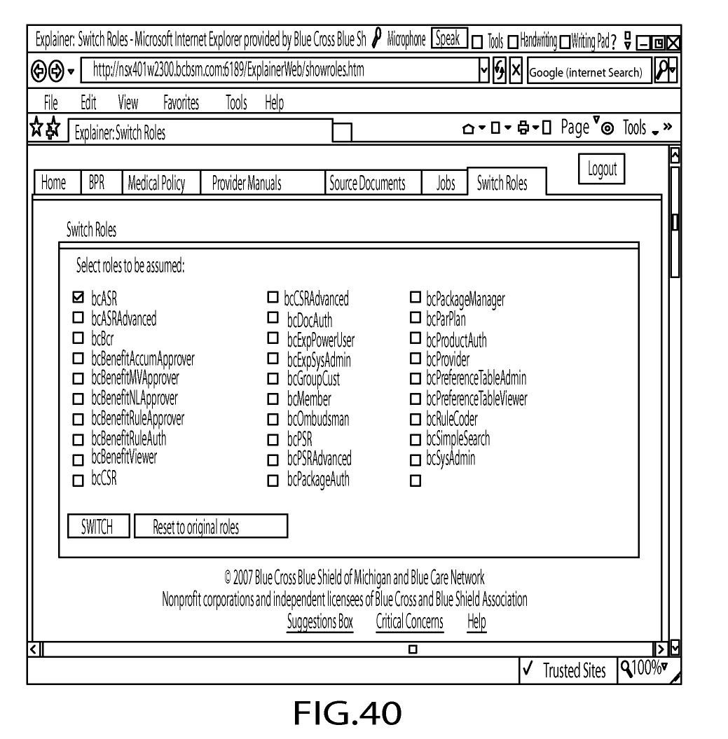

FIGS. 30-40 show diagrams of an interface that could be used to allow a user to move through the various documents within an explainer.

### Connector

Connector 30 is a dynamic interface/translator layer with the BDM 22 to exchange electronic benefit data with external benefit claims systems, such as those that administer membership benefits and process healthcare claim payments (e.g., NASCO) to NETEZZA PERFORMANCE SERVER (“NPS”) (Netezza Corporation Framingham Mass.) and other computer database management and business interfaces for the health care industry, such as METAVANCE (Electronic Data Systems Corporation, Plano, Tex.), to ensure synchronization. The connector 30 is where the benefit configurator excels at automation. Whenever benefit data is needed to be communicated from BDM 22 to another system, the request is made via connector 30. The most complex connection is typically in support of the claims systems.

The NPS 50 code that correlates to a predetermined benefit rule mentioned above can be automatically generated through connector 30 from BDM 22. The benefit configurator system can also incorporate a manual coding capability to support unique situations. All benefit-related NPS code (translated or manually written within the BDM) can be passed to NPS via automated means. The generated code should be compact and efficient to minimize risk due to NPS system construct limitations In any event, connector 30 must provide correct and efficient synchronization of benefit configurator 20 with all external systems associated with the system.

For illustrative purposes only to serve as an example of use of the present invention, BDM 22 can receive group benefit rate information from the host through the editor 26. Editor 26 can be used to update/maintain a set of translation tables. This translation table can share functionality, where possible, with explainer 28. In this instance, explainer 24 can only access and display a subset of data, while the NPS 50 translation can produce a complete set of codes and benefit information. At predefined time intervals, connector 30 can pull a composite of benefit package information (determined through selector 24) needed for membership claims processing. This file of information can be split to NPS 50 for claims processing and METAVANCE for membership and rate data. Any benefit packages considered invalid, for whatever reason, will not be forwarded to METAVANCE. Also, BDM 22 can maintain status data of which benefits to translate and transfer, and to where.

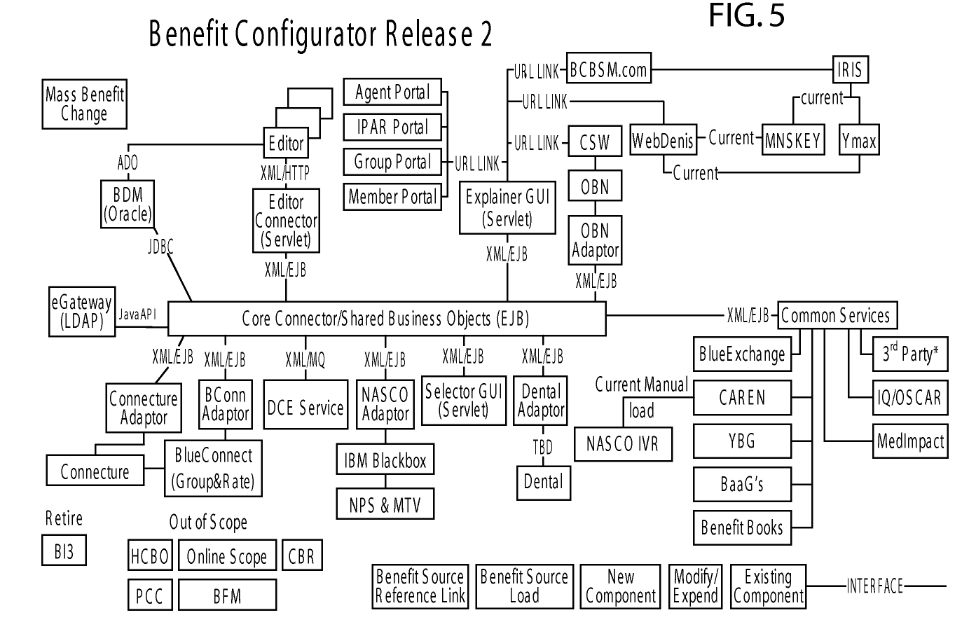

Connector 30 refers to all the interfaces between benefit configurator 20 application and other systems (internal or external to host provider) required to support end-to-end business processes, including other major components of the system. As such, connector 30 is not a single application, but a set of application programming interfaces (APIs) that will support the transfer of data and transactions between various systems that need to function with benefit configurator 20. This is shown with more specificity with the benefit configurator schematic shown in FIG. 5.

Connector 30 can be configured to translate rules from a user's natural language, such as English, to code language common in many external data processing systems. It can also be configured to automatically feed updates to the external systems from benefit configurator 20. These can include such systems as NPS, METAVANCE, CAREN, BLUECONNECT, wed-DENIS, and the like. Thus, included in connector 30 function is the translator capability of generating NPS code from benefit configurator 20 rules. As new internal and/or external systems are developed or implemented, connector 30 can be adapted to accommodate or incorporate them.

Benefits will neither be treated just horizontally (i.e., across all constituents and systems) nor vertically (i.e., supporting a single constituent or system), as neither would meet the end vision of benefit configurator 20. Instead, a hybrid model should be used, leveraging a benefit configurator 20 benefit package and a benefit detail record model, along with some vertical/column identification for single groupings, such as provider services (such as a chiropractor) and/or consolidated groupings of history accumulation rules. This best supports system performance. In all events, a service-oriented architecture is critical.

### An Example Computing and Network Environment

FIG. 44 is a block diagram illustrating a network environment in which a system, according to the present invention, may be practiced. As is illustrated in FIG. 44, network 68, such as a private wide area network (WAN), local area network (LAN), and/or the Internet, includes a number of networked servers 70(1)-(n) (where “n” is a variable noting the number of servers is not limited) that are accessible by client computers 72(1)-(n). Communication between client computers 72(1)-(n) and servers 70(1)-(n) can occur over a publicly accessible network, such as a public switched telephone network (PSTN), a DSL connection, a cable modem connection, or large bandwidth trunks (e.g., communications channels providing T1, T3, OC3 service, and the like), or wireless link. Or the system, in whole or in part, may only be accessible through a non-public accessible network to some or all client computers 72(1)-(n). Client computers 72(1)-(n) may access servers 70(1)-(n) through, for example, a service provider. This might be, for example, an Internet Service Provider (ISP). Access is typically had by executing application-specific software (e.g., network connection software and a browser) on the given one of client computers 70(1)-(n).

One or more of client computers 72(1)-(n) and/or one or more of servers 70(1)-(n) may be, for example, a computer system of any appropriate design, in general, including a mainframe, a mini-computer, or a personal computer system which are known in the art (not shown). Such a computer system typically includes a system unit having a system processor and associated volatile and non-volatile memory, one or more display monitors and keyboards, one or more diskette drives, one or more fixed disk storage devices, and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices, and specialized communication devices. Mass storage devices such as hard disks, CD-ROM drives, and magneto-optical drives may also be provided, either as an integrated or peripheral device.

Many devices or subsystems may be connected in a similar manner (e.g., bar code readers, document scanners, digital cameras, and so on). Conversely, it is not necessary for all of the devices to be present to practice the present invention. The devices and subsystems may also be interconnected in different ways. Code to implement the present invention may be stored in computer-readable storage media, such as one or more of system memory, fixed disk, CD-ROM, floppy disk, or other storage media know in the art. Additionally, the computer system may be any kind of computing device, and so includes personal data assistants (PDAs), cellular phones, network appliances, or other such computing device. The computer system shall also support a number of Internet access tools including, for example, an HTTP-compliant web browser having a JavaScript interpreter.

The foregoing described embodiments the different components that can be contained within different other components (e.g., the various elements shown as components of the computer system). It is to be understood that such depicted architectures are merely examples and that, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other, such that the desired functionality is achieved, irrespective of architectures or intermediate components. Likewise, any two components so associated can also be viewed as being “closely connected” or “closely coupled” to each other to achieve the desired functionality.

A browser running on a computer system can employ a TCP/IP connection to pass a request to server, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

What is claimed is:

1. A computer program-assisted system to provide a single point source for host benefits management, comprising:
a centralized benefit data manager (BDM);
a selector communicatively connected to said BDM;
an editor communicatively connected to said BDM;
a read-only explainer communicatively connected to said BDM; and
a connector communicatively connected to said BDM.

2. The system of claim 1, wherein said BDM comprises at least one benefit package for at least one line of business, said benefit package having at least one product, said product representing a collection of benefit rules.

3. The system of claim 1, wherein said selector allows a user to view, select, and assemble benefit components from BDM into a benefit package per predefined medical, benefit, and payment policies.

4. The system of claim 1, wherein said editor allows those with access the ability to define and update benefit components and variables for benefit and payment policies within BDM.

5. The system of claim 4, further comprising editing functions of documents within the system.

6. The system of claim 1, wherein said explainer builds easily understandable “read-only” descriptions of benefits available at a current or predefined point in time at both a summary and detail rule level to a large variety of potential users.

7. The system of claim 1, wherein said connector 30 is an interface layer to exchange electronic benefit data to all systems associated with said BDM.

8. The system of claim 7, wherein said connector translates rules from a user's natural language to computer code language.

9. A method to configure benefits using an automated benefit database manager (BDM) system residing on a host server and comprising the steps of:
capturing and maintaining in said BDM benefit packages for at least one line of business, said benefit package having at least one product, said product representing a collection of benefit rules;
selecting and assembling benefit components from BDM into a benefit package per predefined medical, benefit, and payment policies;
providing an editor to allow those with access the ability to define and update benefit components and variables for benefit and payment policies within BDM;
providing easily understandable “read-only” descriptions of benefits available at a current or predefined point in time at both a summary and detail rule level to a large variety of potential users; and
connecting said BDM to all external and internal processing systems needing access to the BDM.

10. The method of claim 9, further comprising the step of loading of benefit data to various membership claims processing systems.

11. The method of claim 9, wherein the step of connecting said BDM to processing systems comprises the step of translating rules from a user's natural language to computer code language.
